(19) United States
(12) Patent Application Publication
(10) Pub. No.: US 2024/0185039 A1
(43) Pub. Date: Jun. 6, 2024

(54) SYSTEM AND METHOD FOR MACHINE LEARNING-BASED IDENTIFICATION OF A CONDITION DEFINED IN A RULES-BASED SYSTEM

(71) Applicant: Lexvision Holdings Limited, Cheltenham (GB)

(72) Inventor: Brendan John Hughes, Cheltenham (GB)

(73) Assignee: Lexvision Holdings Limited, Cheltenham (GB)

(21) Appl. No.: 18/529,386

(22) Filed: Dec. 5, 2023

Related U.S. Application Data
(60) Provisional application No. 63/386,095, filed on Dec. 5, 2022.

(51) Int. Cl. G06N 3/0455

(52) U.S. Cl. CPC G06N 3/0455

(57) ABSTRACT

A computing system and method for machine learning-based identification of a condition defined in a rules-based system are provided. A method includes receiving data elements extracted from a record. The method includes processing the data elements, including identifying in the data elements features including one or more of: an entity; a relationship between the entity and another entity; and, attributes of the relationship. A state data structure is compiled based on the entity, relationship and attributes of the relationship identified in the data elements. The state data structure represents the relationship between the entity and another entity. The state data structure is evaluated for occurrence of a condition defined in a rules-based system, including continually or periodically receiving further data elements and evaluating the further data elements against the state data structure for occurrence of the condition. An alert is output when the occurrence is identified or approximated.

### CROSS-REFERENCE TO RELATED APPLICATIONS

This application claims priority from U.S. provisional patent application No. 63/386,095 filed on 5 Dec. 2022, which is incorporated by reference herein.

### TECHNICAL FIELD

This invention relates to a system and method for machine learning-based identification of a condition defined in a rules-based system. The invention may find particular, but not exclusive, application in identifying whether a cause of action has arisen, or may arise, in relation to one or more entities subject to a legal system.

### BACKGROUND

A variety of human, social, economic and other activities are organized and regulated by rules-based systems. The most obvious examples of such systems are so-called “legal systems” however rules-based systems may be used in a variety of different ways to store and manipulate knowledge to interpret information in a useful way. Rules can prescribe that specific actions should be taken in specific circumstances, for example, when a referee should award a penalty for infringement of a rule or where a medical doctor follows a rules-based triage system for prioritizing care for patients or when prescribing particular remedies, treatments or interventions based on the results of diagnostic tests.

Rules-based systems operate not only on sets of rules but also on interpretations of facts or circumstances and on applications of rules to interpretations. Within many rules-based systems, and within legal systems particularly, the actions of interpreting and applying the rules to particular sets of facts and circumstances can be hugely time-consuming and extremely expensive. Litigation, or the process of enforcing or protecting rights through the courts, is often regarded as a process that should only be embarked on by persons with considerable financial means. These characteristics of legal systems present significant problems to societies who seek to regulate relationships between subjects based upon the principle of the rule of law.

Information relating to litigious entities, or potentially litigious entities, is also generally regarded as highly confidential and frequently sensitive in nature and requires a high degree of protection to be applied to it.

There exists a great need to discover new and substantially better ways of identifying or anticipating whether a cause of action has arisen in terms of the rules or may be anticipated to arise on a relative scale of probabilities and specifically to do so in a far more time- and cost-effective and secure manner.

Much progress has already been made in the field of corpus processing and content extraction, including natural language processing (“NLP”), using computational and other techniques, including, but not limited to, machine learning techniques.

A lot of research and experimentation has been conducted over the last three decades focusing on techniques that enable unstructured text to be processed for named entity recognition, including by finding and linking all name and nominal (description) mentions of an entity across a (potentially multilingual) corpus into a single entity representation, and for linking that entity to a pre-existing knowledge base if the entity is in the knowledge base, or creating a new knowledge base entry for a new entity.

General purpose large language models (“LLMs”) have also been developed to analyze data and to recognize, summarize, predict and/or generate text and other forms of content based on data inputs and/or user queries.

Domain-specialized language models have also been developed focusing on language and text found within specialized domains to better address challenges associated with the complexities of domain-specific or domain-relevant concepts and language, as well as domain specific formats. These include legal language models which can be used to assist legal professionals in tasks such as legal research, contract analysis and legal document summarization as well as medical language models which can be used to generate clinical summaries and suggest answers to patient health questions or tests. However, LLMs that generate, induce or infer rules from their observations may amplify biases contained within training data sets and may produce linguistically plausible but nonetheless incorrect outputs based on statistical probability assessments of language inputs rather than on relational reasoning and rules-based assessments of the relevant factual inputs. Furthermore, recent research indicates that LLM performance is often highest when relevant information occurs at the beginning or end of input context and significantly degrades when models must access relevant information in the middle of long contexts, even for explicitly long-context models.

Further methods are therefore needed to create learning frameworks catering for explicitly defined and/or externally defined rules and for considering a high number of potentially relevant and/or irrelevant inputs distributed across potentially very wide ranging and very long spanning input contexts.

Systems and methods have already been developed to enable human-assisted machine learning techniques to be applied to a corpus of information so as to automatically identify or categorize documents within that corpus. Within the legal domain, such systems include systems that are able to identify documents that are likely to be legally privileged or relevant to the issues known or reasonably anticipated to be in dispute between litigants once the actual or potential onset of litigation has been identified. Document reviewers, typically trained lawyers or paralegals who have become reasonably versed in the legal and factual issues that may be relevant to a particular case, label documents within a corpus according to their privilege status and according to their relevancy status in relation to the issues in dispute in that case. In cases consisting of large enough quantities of documents to create sufficiently representative learning samples, machine learning methods are presently capable of being utilized to enable automatic identification and labelling of documents within the corpus as either privileged, relevant or irrelevant in relation to the same case from which the training data was sourced and, to a more limited extent, potentially in other cases as well. These methods reduce the amount of time that document reviewers need to devote to reviewing potentially privileged and relevant information in large cases, thereby reducing the costs typically associated with such cases.

Notwithstanding all of the above, methods for identifying the emergence of legal actions or risk of legal actions emerging between entities or of determining the legal merits of any such actions or potential actions and reporting on those observations in terms of the legal rules still routinely require substantial human involvement (such as time-consuming human reading, considering, interpretating and/or judgment to be applied to questions of both fact and law) and/or the merging of point-disparate sources of information, which could be vast both in terms of the quantity of information and the number and range of devices and locations at which that information is located for many litigious matters, into one or more separate data locations for processing, and/or the transferring of potentially highly confidential, privileged and/or sensitive information to or across potentially insecure points in an information network.

The merging of disparate sources of information into a central database presents information security risks to the entities to whom that information relates as potentially confidential and sensitive information needs to be gathered and collated under the control of a central custodian. Furthermore, the transportation of data, including the transfer of data from its point of origin across a third party or multiparty network to a new location, also presents obvious information security risks. These information security risks are particularly significant for certain categories of confidential, sensitive or privileged entity information, such as legal, medical and financial information related to identifiable entities. In recent years, these risks have received heightened attention of data controllers, data subjects, technical standards organizations, governments and regulators and an expectation has developed that persons processing such categories of information should be required to do so using adequate technical measures that ensure an appropriate level of security for the type of information being processed and that such persons should, in certain cases, be penalized where they have failed to do so.

Within the context of litigation specifically, data is generally only merged into a central database for litigation processing if there is actual pending litigation relating to the data, or a reasonable anticipation of litigation. This problem can be overcome by routinely transporting and merging all data sources into a central database, even where litigation is not already known or reasonably anticipated. However, routinely transporting and merging all data sources using current methods has cost, data storage size and information security disadvantages.

There is accordingly considerable scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY

In accordance with an aspect of the invention there is provided a computer-implemented method for machine learning-based identification of a condition defined in a rules-based system comprising: receiving, from a data source, data elements extracted from a record; processing the data elements, including identifying in the data elements features including one or more of: an entity; a relationship between the entity and another entity; and, attributes of the relationship; compiling a state data structure in the form of a graph data structure based on the entity, relationship and attributes of the relationship identified in the data elements, wherein the state data structure represents the relationship between the entity and another entity; evaluating the state data structure for occurrence of a condition defined in a rules-based system by a model which represents a collection of conditions defined in the rules-based system, wherein the model is trained using machine learning applied to training data comprising corpora of information which include data elements relating to: entities, relationships, attributes of relationships and one or more conditions of the collection of conditions, and wherein evaluating the state data structure by the model includes continually or periodically receiving further data elements and evaluating the further data elements against the state data structure for occurrence of the condition; and, outputting an alert when the occurrence of a condition is identified or approximated, wherein the alert includes an indication of the condition.

The model may be trained using machine learning applied to training data comprising corpora of information which include labelled data elements relating to: entities, relationships, attributes of relationships and one or more conditions of the collection of conditions.

The state data structure may be in the form of a graph data structure including a fact graph database and a rules graph database. Evaluating the state data structure may include using node and node path similarity algorithms to determine the distance between embedded node-paths relating to an entity in the fact graph database and embedded node-paths in the rules graph database for entities of that particular entity type.

Identifying features in the data elements may include recognizing, classifying and/or labelling the data elements using one or more entity recognition algorithms. The one or more entity recognition algorithms may include one or both of: conditional random fields; and, hybrid bi-directional long short-term memory/convolutional neural networks (LSTM-CNN). Identifying features in the data elements may include using one or more classifiers. Identifying features in the data elements may include using one or more of: an entity-type classifier; an entity-relationship classifier; and, an entity-role, rights and/or obligations classifier. The attributes of the relationship may include one or more of: an entity role in the relationship; an entity obligation in the relationship; and/or an entity right in the relationship.

The model may be an entity-relational model for a rules-based system in which ontological elements include one or more of “entities”, “relationships”, “actions” and “events”. The condition may be a threshold against which data elements within the state data structure are evaluated to determine when the threshold is met. The rules-based system may be an entity relational rules-based system. The entity relational rules-based system may be a legal system. The condition may be a cause of action arising in the relationship between the entity and another entity. The data elements may include or represent natural language phrases extracted from a natural language record.

Processing the data elements may include assigning pseudonymized identifiers to entity identities identified in the data elements by performing a cryptographic operation on each of the entity identifiers to generate a corresponding pseudonymized identifier. Assigning pseudonymized identifiers to entity identities identified in the data elements may include creating a pseudonymized value register of all extracted entities by performing the cryptographic operation on an entity item at the information point at which the entity item has been recognized or extracted. Assigning pseudonymized identifiers may include transmitting the pseudonymized identifiers to an entity register for co-referencing standardization. Transmitting pseudonymized entity identifiers may include transmitting a standardized name to the information point from which the entity item was extracted. The method may include recording pseudonymized entity related information at one or more data locations in a federated database system.

The alert may be transmitted to and output via a user device. The alert may include a confidence or proximity score associated with the identification. The user device may be a device associated with an entity in the relationship.

In accordance with a further aspect of the invention there is provided a system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising: receiving, from a data source, data elements extracted from a record; processing the data elements, including identifying in the data elements features including one or more of: an entity; a relationship between the entity and another entity; and, attributes of the relationship; compiling a state data structure in the form of a graph data structure based on the entity, relationship and attributes of the relationship identified in the data elements, wherein the state data structure represents the relationship between the entity and another entity; evaluating the state data structure for occurrence of a condition defined in a rules-based system by a model which represents a collection of conditions defined in the rules-based system, wherein the model is trained using machine learning applied to training data comprising corpora of information which include data elements relating to: entities, relationships, attributes of relationships and one or more conditions of the collection of conditions, and wherein evaluating the state data structure by the model includes continually or periodically receiving further data elements and evaluating the further data elements against the state data structure for occurrence of the condition; and, outputting an alert when the occurrence of a condition is identified or approximated, wherein the alert includes an indication of the condition.

In accordance with a further aspect of the invention there is provided a computer program product for machine learning-based identification of a condition defined in a rules-based system, the computer program product comprising a non-transitory computer-readable medium having stored computer-readable program code for performing the steps of: receiving, from a data source, data elements extracted from a record; processing the data elements, including identifying in the data elements features including one or more of: an entity; a relationship between the entity and another entity; and, attributes of the relationship; compiling a state data structure in the form of a graph data structure based on the entity, relationship and attributes of the relationship identified in the data elements, wherein the state data structure represents the relationship between the entity and another entity; evaluating the state data structure for occurrence of a condition defined in a rules-based system by a model which represents a collection of conditions defined in the rules-based system, wherein the model is trained using machine learning applied to training data comprising corpora of information which include labelled data elements relating to: entities, relationships, attributes of relationships and one or more conditions of the collection of conditions, and wherein evaluating the state data structure by the model includes continually or periodically receiving further data elements and evaluating the further data elements against the state data structure for occurrence of the condition; and, outputting an alert when the occurrence of a condition is identified or approximated, wherein the alert includes an indication of the condition.

In accordance with a further aspect of the invention there is provided a computer-implemented method comprising: receiving, from a data source, data elements extracted from a record; processing the data elements, including identifying in the data elements features including one or more of: an entity; a relationship between the entity and another entity; and, attributes of the relationship; compiling a state data structure based on the entity, relationship and attributes of the relationship identified in the data elements, wherein the state data structure represents the relationship between the entity and another entity; and, evaluating the state data structure for occurrence of a condition defined in a rules-based system, including continually or periodically receiving further data elements and evaluating the further data elements against the state data structure for occurrence of the condition.

In accordance with a further aspect of the invention there is provided a computing system including a memory for storing computer-readable program code and a processor for executing the computer-readable program code, the system comprising: a receiving component for receiving, from a data source, data elements extracted from a record; a processing component for processing the data elements, including identifying in the data elements features including one or more of: an entity; a relationship between the entity and another entity; and attributes of the relationship; a compiling component for compiling a state data structure based on the entity, relationship and attributes of the relationship identified in the data elements, wherein the state data structure represents the relationship between the entity and another entity; and, an evaluating component for evaluating the state data structure for occurrence of a condition defined in a rules-based system, including continually or periodically receiving further data elements and evaluating the further data elements against the state data structure for occurrence of the condition.

In accordance with a further aspect of the invention there is provided a computer program product comprising a computer-readable medium having stored computer-readable program code for performing the steps of: receiving, from a data source, data elements extracted from a record; processing the data elements, including identifying in the data elements features including one or more of: an entity; a relationship between the entity and another entity; and, attributes of the relationship; compiling a state data structure based on the entity, relationship and attributes of the relationship identified in the data elements, wherein the state data structure represents the relationship between the entity and another entity; and, evaluating the state data structure for occurrence of a condition defined in a rules-based system, including continually or periodically receiving further data elements and evaluating the further data elements against the state data structure for occurrence of the condition.

The data elements may represent natural language phrases and the record may be a natural language record.

The computer-readable medium may be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1A is a flow diagram which illustrates an example embodiment of a method for building an entity-type classifier according to aspects of the present disclosure;

FIG. 1B is a flow diagram which illustrates an example embodiment of a method for building an entity-relational rights and/or obligations classifier according to aspects of the present disclosure;

FIG. 1C is a flow diagram which illustrates an example embodiment of a method for building stored representations of rules according to aspects of the present disclosure;

FIG. 1D is a flow diagram which illustrates an example embodiment of a method for machine learning-based identification of a condition defined in a rules-based system in accordance with aspects of the present disclosure;

FIG. 2A is a schematic diagram which illustrates a sale contractual relationship between two legal entities, where the subject of the sale is any non-legal entity or object in a hypothetical legal system;

FIG. 2B is a schematic diagram which illustrates a sale contractual relationship between two particular legal entities where the subject of the sale is a particular motor vehicle;

FIGS. 3A-3G are schematic diagrams which illustrate example representations of parsing and tagging necessary elements according to aspects of the present disclosure;

FIGS. 4A-4G are schematic diagrams which illustrate example representations of parsing and tagging equivalent phrases according to aspects of the present disclosure;

FIGS. 5A-5B are schematic diagrams which illustrate example representations of parsing and tagging two phrases which are semantically equivalent to the phrase illustrated in FIG. 3B;

FIGS. 6A-6B are schematic diagrams which illustrate for two example conditions in which necessary elements of the respective conditions are encoded as a series of conditionals;

FIG. 7 is an example of an artefact representing a contract for the sale of a motor vehicle;

FIG. 8 is a schematic diagram showing an example computing system for machine learning-based identification of a condition defined in a rules-based system according to aspects of the present disclosure; and

FIG. 9 illustrates an example of a computing device in which various aspects of the disclosure may be implemented.

### DETAILED DESCRIPTION

Aspects of the present disclosure relate to a system and method for machine learning-based identification of a condition (including a set of conditions) defined in a rules-based system. The condition which is identified may be a predefined state of being of one entity in relation to another entity in terms of which the one entity has some obligation or some right in relation to the other entity. In one example embodiment, the rules-based system is a legal system, and the condition is a set of facts that give rise to a cause of action.

Aspects of the present disclosure provide a system and method for plotting an entity-relational based rules ontology into a numeric graph-based data structure and measuring correlations between such representations of the rules. Pseudonymized representations of real entity relations may be held across federated graph-based data structures. This may provide information security benefits and speed and cost benefits in relation to the process of identifying risk events or causes of action in terms of those rules because the method can, for example, be utilized to automatically identify the occurrence of a condition described in the rules from data contained in one or more data sets and without causing any entity identifying information to be transferred across a data network or otherwise moved between data locations.

In most legal systems, a “cause of action” refers to a particular type of legal action or legal claim that arises under particular factual conditions or circumstances. The Latin expression “facta probanda” is used to refer to the particular factual elements of a cause of action which must be proven in order for that cause of action to be sustained. The expression “facta probantia” refers to facts which tend to evidence the existence of the facta probanda relating to a legal action.

A particular cause of action may be considered a particular, predefined threshold against which a set of data elements, or features extracted from the set of data elements, may be evaluated to determine whether or not the threshold is met (and hence the cause of action has arisen). Aspects of the present disclosure may therefore entail evaluating a set of data elements for identifying features associated with the data elements and evaluating the identified features against one or more predefined condition thresholds to determine whether any such thresholds are met. This may for example include identifying factual data elements within the set of data elements and evaluating the identified factual data elements against required data elements associated with each of a number of predefined thresholds. If all of the required data elements of a predefined threshold are identified, the threshold may be met, indicating, in some embodiments, that a cause of action has arisen.

Some aspects of the present disclosure relate to a system and method for machine learning-based evaluation of data elements or features extracted from data elements against a predefined threshold.

In particular, aspects of the present disclosure relate to a system and method for processing a set of data elements containing information to identify the emergence, or potential emergence, of legal actions between entities, or for determining the potential legal merits of any such actions. Processing of the data elements and identification or detection of the condition may be conducted automatically.

Identification of a condition may also signal a risk event in terms of which remedial or mitigatory action ought to be taken. In some embodiments, an alert or other notification may be output to a user via a user interface in response to detecting or identifying occurrence of the condition. In this way, action may be initiated to remedy or mitigate damage or other consequences that may flow from or otherwise be associated with the relevant condition.

Aspects of the present disclosure may find application in the large-scale processing of data elements on a continual or periodic basis or on an event driven basis.

In some cases, a set of data elements may be contained in and extractable from a collection of files, records, entries and/or other suitable data structures. The data elements may represent natural language phrases extracted from a natural language record. The data elements within the set of data elements may include for example a record, artefact, store, repository, token or other piece of data or information. The set of data elements may thus in turn represent a digitized “corpus” of information, which corpus may include information expressed in natural language phrases and other information formats or which may be converted between natural language and other information formats. Within the set of data elements, there may be data elements which are associated with or indicative of facts or factual conditions or circumstances.

The system and method described herein may be configured for processing such data elements in a real-time or near real-time environment, with minimum to no human involvement in the operation of the system. The system and method described herein may be configured to process such data elements without: merging point-disparate sources of information into one or more data locations for processing; and/or, transferring potentially highly confidential or sensitive information to, or across, potentially insecure points in a network.

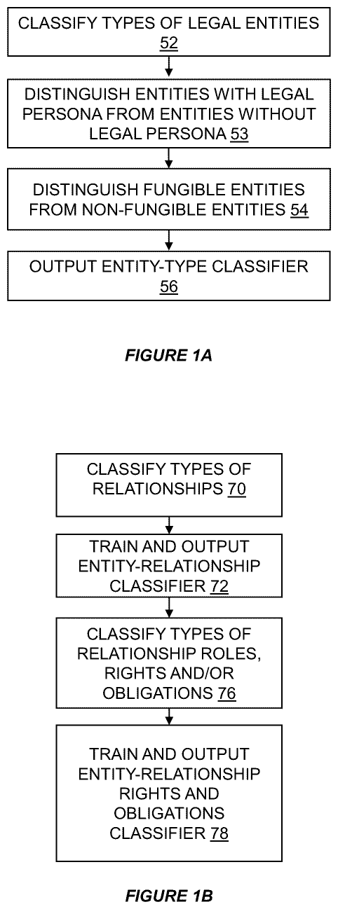

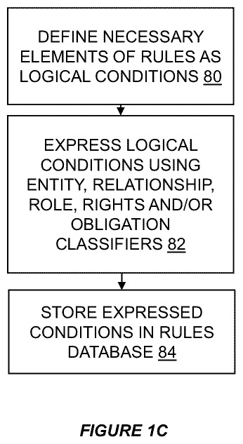

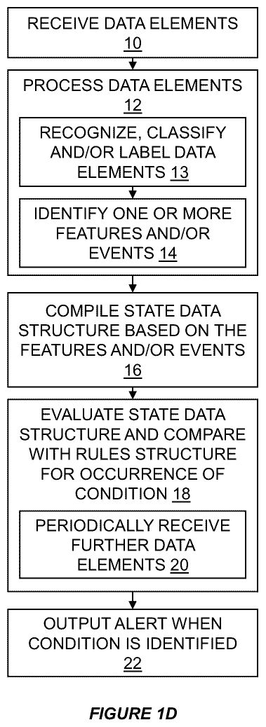

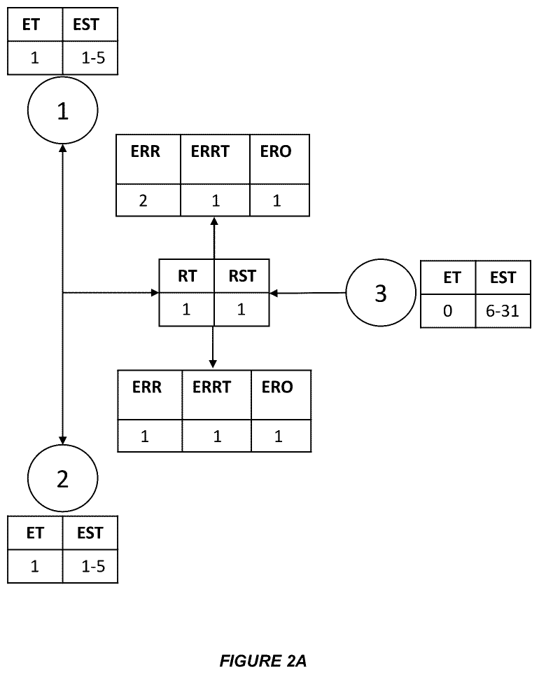

FIG. 1A is a flow diagram which illustrates an example embodiment of a method for machine learning-based identification of a condition defined in a rules-based system. The method may be executed by a computing device.

The method may include receiving (10) data elements. The data elements may include natural language phrases extracted from a natural language record. The natural language record from which the data elements are extracted may form part of a corpus of data or information. The data elements may be received from a data source, such as a user device, computer disk, database or the like, including via a data communication network. In some embodiments, receiving the data elements includes receiving an artefact, document or other information source and extracting the data elements from the source (e.g., using optical character recognition, etc.).

The method may include processing (12) the data elements. Processing (12) the data elements may include recognizing, classifying and/or labelling (13) the data elements using one or more entity recognition algorithms such as conditional random fields or, in an exemplary embodiment, hybrid bi-directional long short-term memory/convolutional neural networks, and entity classifiers, including for example one or more of entity-type classifiers; entity-relationship classifiers; and/or entity-role classifiers. Entity classifiers may, for example, be used to distinguish between legal entities and non-legal entities as well as between fungible and non-fungible entities. Recognizing, classifying and/or labelling (13) the data elements may include classifying and/or labelling the types of relationships that may arise between said entities using selected entity-relationship classifiers. Classifying and/or labelling (13) the data elements may include classifying and/or labelling the roles that may be occupied by the entities in the relationships using selected entity-role classifiers and/or classifying the types of rights or obligations that may be held by entities in relation to other entities.

Processing the data elements may include classifying information contained in the data elements into data structures and formats capable of being processed and/or queried by computing devices for the purposes of training and/or utilizing a model (e.g., a machine learning model, such as a neural network) to extract, classify and identify features from sets or corpora of data. The features may include data elements relating to different entities, attributes relating to those entities, the existence of different types of relationships between those entities and other entities, the nature of those relationships, the roles occupied by entities within those relationships, the rights and obligations of those entities held in relation to those roles, as well as other features and facts, including but not limited to entity related events, which are indicative of a particular cause of action having arisen within a particular rules-based system and further facts whose presence or absence are indicative of the existence or absence of the aforementioned facts or relevant conditions.

Processing the data elements may include identifying (14), in the data elements, features including one or more of: an entity; a relationship between the entity and another entity; and, attributes of the relationship. The attributes of the relationship may include one or more of: an entity role in the relationship; an entity obligation (or responsibility) in the relationship; an entity right in the relationship. Some or all of the features may represent facts, or states of being, associated with the entity and/or the relationship.

In some embodiments, processing the data elements may include assigning pseudonymized identifiers to entity identities identified in the data elements. Assigning pseudonymized identifiers may be by using a deterministic pseudonymization algorithm (e.g., a cryptographic or encryption algorithm) and may include creating a pseudonymized value “register” of all extracted entities by applying a pseudonymizing algorithm to an entity item at the information point at which the entity has been recognized or extracted. In an exemplary embodiment, assigning pseudonymized identifiers may include transmitting pseudonymized entity identifiers or names generated by a deterministic pseudonymization algorithm to an entity register for co-referencing standardization purposes and, in some embodiments, by transmitting the standardized name, or a pseudonymized version of that name, back to the information point or store from which the entity name was extracted. This may overcome the problem of creating more than one separate value for entities known by more than one name or by more than one spelling of that name. This may include assigning pseudonymized identifiers to inconsistently referenced entities using an entity referencing standardization system. The method may include recording pseudonymized entity related information at one or more data locations in a federated database system (which term should be understood herein to include sharded database systems). In some embodiments, the method may include assigning anonymized or pseudonymized identifiers to entities using a synchronizing identity management system.

In some embodiments, identifying data elements relating to entities and assigning pseudonymized identifiers to entity identities identified in the set of data elements may be conducted by an entity identification and pseudonymization component which executes locally at the data source from which the set of data elements is received. This may prevent sensitive data relating to an entity from leaving a data source maintained, operated or controlled by that entity.

Once entity names have been pseudonymized, further data about those entities may be extracted from the set of data elements and linked to pseudonymized entity identifiers for pooling into either a centralized or federated database system. As a result, only pseudonymized entity identities linked to facts, attributes or relationship counterparty identities are passed across a network in the composition of the centralized or federated database.

In some embodiments, the method may include supplementing device-extracted data elements with other known data elements or features relating to identified entities. This may include processing broader source data, for example being accessible from third party data repositories, using consistent entity pseudonymizing techniques to enable accurate entity matching and records linking in the data supplementation process. Supplemented or non-supplemented data contained in the databases may be queried for correlations with the legal domain knowledge base and matches, or near matches according to a match threshold specified as a matter of policy by the user, reported on. Various algorithms that efficiently search for pattern occurrences, matches or proximate matches may be deployed for this purpose. In an exemplary embodiment, continuous querying of a federated graph database system for correlations with the conditions required to establish a cause of action may be performed using node and node path similarity algorithms and may include using a lower-limit similarity value or score as a threshold condition to generate an output report. In a further exemplary embodiment, reports generated by the method could include generating a natural language summary of the relevant facts that caused a correlation to arise by converting the relevant facts represented in the knowledge graph to natural language format, using such natural language reports as inputs to a LLM that had been sufficiently trained on domain relevant texts such as, in the case of a legal system, historical law reports and generating a further natural language report on the existence, nature and extent of the legal remedies available to an entity in relation to the causes of action arising in terms of the rules reported on.

The method may include compiling (16) a state data structure based on the features and/or events. The state data structure may for example be any suitable data structure or collection of data structures compiled based on the entity, relationship and attributes of the relationship identified in the data elements. The state data structure may include entity identifiers (which may be pseudonymized) and other features. The state data structure may represent and/or describe the condition of the entity, including for example the relationship between the entity and another entity and optionally attributes of that relationship.

The state data structure may describe and/or record the relationships that may arise between entities within the rules-based system, including the roles, rights and/or obligations that may be held by such entities within such relationships. In a practical implementation, there may be a state data structure for each entity. In some implementations, there may be a plurality of state data structures for each entity (for example, one for each relationship between the entity and other entities). In this manner, in a practical implementation, a collection of state data structures may be maintained (for example in a state data structure store) and the state data structures may be linked to each other by way of one or more of: entity identifiers; relationship identifiers; and, artefact identifiers.

The method may include using graph data structures and vectors holding numeric, character, integer, logical and/or complex data types to: use entity-nodes in a graph database (such as Neo4j) to represent entities; use edges in a graph database to represent events; use directional edges between nodes to represent relationships between entities and between entities and events; codify representations of entities (including objects) using vectors of n-length and x-y value range, where n represents the number of classification dimensions that describe the different attributes of the aforesaid entities and where x and y represent a range of values that may be assigned to any such dimension; codify representations of entity-relationships using vectors of n-length and x-y value range, where n represents the number of classification dimensions that describe the different types of relationships that entities may inhabit and where x and y represent a range of values that may be assigned to any such dimension; codify representations of relationship-roles using vectors of n-length and x-y value range, where n represents the number of classification dimensions that describe the different types of roles that entities may inhabit in different types of relationships and where x and y represent a range of values that may be assigned to any such dimension; codify representations of entity-rights using vectors of n-length and x-y value range, where n represents the number of classification dimensions that describe the different types of rights that may be associated with entities in relationships and where x and y represent a range of values that may be assigned to any such dimension; codify representations of entity-obligations using vectors of n-length and x-y value range, where n represents the number of classification dimensions that describe the different types of obligations that may be associated with entities in relationships and where x and y represent a range of values that may be assigned to any such dimension; codify representations of entity-events using vectors of n-length and x-y value range, where n represents the number of classification dimensions that describe the different types of events that may be associated with different types of entities and where x and y represent a range of values that may be assigned to any such dimension; use rules to capture and describe, for the purposes of creating and maintaining a rules graph database, the different types of events relating to different types of entities in different types of relationships with different types of relationship roles, rights and/or obligations, the occurrence of which events would give rise to different types of causes of action between those different entities; use named entity recognition, fact extraction and vector-encoding algorithms, including, in an exemplary embodiment complex-valued extensions of the bilinear model for knowledge graph embedding, to create and maintain a fact graph database, to identify entities, create entity-nodes and embed entity-nodes with coded value vectors describing the entities giving rise to the nodes; identify events, create event-edges and embed with coded value vectors describing the actions giving rise to the events; identify relationships between entities, create edges between related entities and embed incoming and outgoing edges to related entity-nodes with coded value vectors describing the roles, rights and/or obligations arising in terms of the relationships represented by those edges; and identify relationships between entities and events, create edges between related entities and embed incoming and outgoing edges to related entities—with coded value vectors describing the events arising in terms of the relationships represented by those edges.

The method may include evaluating (18) the state data structure for occurrence of a condition defined in the rules-based system. In some cases, the condition may be a threshold against which data elements or features within the state data structure are evaluated to determine when the threshold is met.

Evaluating (18) the state data structure for occurrence of the condition may include identifying one or more suitable relationship-type data structures. This may include using features contained in the state data structure, for example, to identify an appropriate relationship-type data structure. The identifying may include matching features to necessary elements of one or more relationship-type data structures. The identifying and/or evaluating may be performed by an algorithm trained using a corpus of information stored in a training data store.

In an exemplary embodiment, evaluating the state data structure may include, for any given entity-node in the fact graph database, using node and node path similarity algorithms to determine the distance between embedded node-paths relating to that entity in the fact graph database and embedded node-paths in the rules graph database for entities of that particular entity type and/or, for any given rule, determining the distance between the embedded node-paths in the rules graph database for that particular rule in the rules graph database and embedded node paths in the fact graph database for any particular entity.

In some embodiments, evaluating (18) the state data structure for occurrence of the condition may include continually and/or periodically receiving (20) further data elements and evaluating the further data elements against the state data structure for occurrence of the condition. This may include comparing the further data elements against data elements contained in the state data structure to identify any inconsistencies or changes that may be associated with a condition.

Evaluating the state data structure for occurrence of the condition may include using a model which represents a collection of conditions defined in the rules-based system. In some embodiments, the rules-based system is a legal system, and the condition may be a cause of action arising in the relationship between the entity and another entity. The model may be trained using machine learning techniques applied to training data comprising one or more corpora of information which may include labelled or encodable data elements relating to: entities, relationships, attributes of relationships and one or more conditions of the collection of conditions.

In some embodiments, the model may describe and/or represent rules of the rules-based system, for example as sets of conditional-if statements and logical assertions and/or as embedded node paths in a graphed data representation of the rules. The model may describe and/or represent rules of the rules-based system using an ontological framework that includes elements of one or more of entities, relations, objects, attributes, actions and events. In some embodiments, the model may describe and/or record the particular causes of action that may arise between natural or juridical entities within the rules-based system, and optionally remedies associated with such actions. In some embodiments, the model may describe and/or record the specific elements (or facta probanda in some cases) that are necessary to sustain a particular cause of action within a rules-based system.

It should be appreciated that the model may be in the form of a collection of different models. For example, in some embodiments, each relationship type within the relevant rules-based system may be associated with a model that describes that relationship type. In such a case, evaluating the state data structure for occurrence of the condition may include using a model for the relationship type identified in the data elements of the state data structure.

Evaluating (18) the state data structure for occurrence of the condition defined in the rules-based system may include identifying or anticipating, from sets or corpora of data, whether, in relation to one or more natural or juridical entities subject to the rules-based system, a particular risk event or cause of action or a right to a particular remedy has arisen, or may be anticipated to arise on a relative scale of probabilities assessed in accordance with specified or predefined probability thresholds and/or proximities. This evaluation may be performed without causing information regarding an identified natural or juridical entity to be transferred across a data network or otherwise moved between data locations.

Identification of the condition based on evaluation of the state data structure may signal a risk event, such as a cause of action or other claim for or against the entity.

The method may include outputting (22) an alert when the condition is identified or approximated. The alert may include an indication of the condition (i.e., the alert may specify the condition that has been identified). The alert may include a confidence or proximity score associated with the identification (e.g., an indication of the probability associated with identification of the condition). The alert may be sent to a user device associated with an entity in the relationship and may include information usable by the entity in remedying or alleviating risk associated with the condition. In some cases, multiple entities may be notified including entities not directly affected by the event. The alert may cause output of a notification (including an audio and/or haptic notification).

The system and method described herein may implement a model for a rules-based system in which key ontological elements include “entities” (each with a potential multitude of different “attributes”) and “relationships” in terms of which entities vested with the attribute of personality may occupy different roles relative to other entities (with a multitude of potential rights and responsibilities associated with those entities in those relationships or roles). Other ontological elements may include “actions” or “events” which have either occurred or not occurred, including by entities either taking or not taking certain actions. Various other elements may be provided for in the ontological model such as “subjects” and “objects”, as well as, in an exemplary embodiment, measurements, quantities and temporal and spatial co-ordinates. It should be recognized that within such a rules-based system one entity's “rights” may frequently also be expressed as the inverse of another entity's “responsibilities” and that references to the existence of a right may automatically imply the existence of an inverse responsibility and vice versa with “rights” being conceived of as actions or benefits that an entity is entitled to receive from another and “obligations” as actions or benefits that an entity is obliged to provide to another.

By way of example, suppose there is a legal system that recognizes two primary types of entities being legal entities (or entities that have legal personality) and non-legal entities (or entities that do not have legal personality). Suppose that within those entities that have legal personality, there are five sub-types of entities being natural person minors, natural person majors, private corporations, public corporations and governments. Each of these sub-types of entities may be assigned an entity sub-type value ranging from 1 to 5. Suppose further that within those entities that do not have legal personality there exists a range of other entities of various sub-types, represented herein for convenience by a letter value range of A-Z and a numeric value range of 6-31. Suppose that within this range of sub-types of entities that do not have legal personality there exists the sub-type of a motor vehicle object which may be assigned a letter value of M and a numeric value of 18.

Table 1 below depicts the different types of entities recognized in the hypothetical legal system.

TABLE 1

| | | | Entity |
|---|---|---|---|
| Entity Type | Entity Type # | Entity Sub-Type | Sub-Type # |
| Legal Entity | 1 | Natural Person Minor | 1 |
| | | Natural Person Major | 2 |
| | | Private Corporation | 3 |
| | | Public Corporation | 4 |
| | | Government | 5 |
| Non-Legal Entity | 0 | A | 6 |
| | | M | 18 |
| | | Z | 31 |

Suppose further that four different types of legal relationships may arise between entities having legal personality, being contractual relationships, communal relationships, familial relationships and governmental relationships. All legal entities within a common legal system may be assumed to be related in law as members of that communal system although the specific legal rights and obligations that they have vis-à-vis each other may be suspensive and/or become effective dependent on the nature of any other or further relationships that they may have and/or the occurrence of particular events. For example, persons may have the general right to act with force in self-defense but a general obligation to refrain from harming others save where acting in self-defense and such rights and obligations would be enforceable against specific persons in specific contexts or events. Suppose further that four different types of contracts may arise in that legal system being sales contracts, employment contracts, license contracts and lease contracts. Suppose further that all persons within that legal system are recognized as being part of a legal community; that only one type of familial relationship has legal status, being the parent-child relationship; and that only one type of governmental relationship has legal status, being the relationship between citizen and state.

Table 2, below, depicts these different relationship types, relationship sub-types and the associated roles, rights and responsibilities that are recognized within this hypothetical legal system together with the assigned numeric values associated with each of the recognized relationship types, relationship sub-types, roles, rights and responsibilities or obligations. In the table below, “RT” means ‘Relationship Type”, ““RST” means “Relationship Sub-Type”, “ERR” means “Entity Relationship Role”, “ERRT” means “Entity Relationship Rights” (being the actions or benefits that an entity is entitled to receive in terms of that relationship) and “ERO” means “Entity Relationship Obligations” (being the actions or benefits that an entity is obliged to perform or deliver in terms of that relationship). The roles that entities occupy in relationships may therefore also be conceived of as “action” roles or positive of negative “performance” roles. For convenience, each relational role is depicted below as a paired relationship with one other relational role in which the relevant entities occupy only one role in relation to each other, however two or more entities may occupy multiple different types of relationships or multiple types of roles in relation to each other. Column headers in the table below containing a #symbol indicate that numeric value classifiers have been assigned to the relevant classification type or sub-type detailed in the Table.

TABLE 2

| | | | | | | | ERRT | | |
|---|---|---|---|---|---|---|---|---|---|
| RT | RT# | RST | RST# | ERR | ERR# | ERRT | # | ERO | ERO# |
| Contractual | 1 | Sale | 1 | Purchaser | 1 | To receive | 1 | To pay for | 1 |
| | | | | | | delivery of | | goods sold | |
| | | | | | | goods sold | | and | |
| | | | | | | | | delivered | |
| | | | | Seller | 2 | To receive | 1 | To deliver | 1 |
| | | | | | | payment | | goods sold | |
| | | | | | | for goods | | | |
| | | | | | | sold and | | | |
| | | | | | | delivered | | | |
| | | Employment | 2 | Employer | 1 | To receive | 1 | To pay for | 1 |
| | | | | | | services | | services | |
| | | | | | | | | rendered | |
| | | | | Employee | 2 | To receive | 1 | To render | 1 |
| | | | | | | payment | | services | |
| | | | | | | for | | | |
| | | | | | | services | | | |
| | | | | | | rendered | | | |
| | | License | 3 | Licensor | 1 | To receive | 1 | To permit | 1 |
| | | | | | | payment of | | use of | |
| | | | | | | license | | licensed | |
| | | | | | | fees or | | property | |
| | | | | | | royalties | | | |
| | | | | Licensee | 2 | To receive | 1 | To pay | 1 |
| | | | | | | access to | | license | |
| | | | | | | and use of | | fees or | |
| | | | | | | the | | royalties | |
| | | | | | | licensed | | | |
| | | | | | | property | | | |
| | | Lease | 4 | Lessor | 1 | To receive | 1 | To provide | 1 |
| | | | | | | payment of | | access to | |
| | | | | | | rent | | leased | |
| | | | | | | | | property | |
| | | | | | | | | To permit | 2 |
| | | | | | | | | use and | |
| | | | | | | | | enjoyment | |
| | | | | | | | | of leased | |
| | | | | | | | | property | |
| | | | | Lessee | 2 | To receive | 1 | To pay | 1 |
| | | | | | | access to | | rent | |
| | | | | | | leased | | | |
| | | | | | | property | | | |
| | | | | | | To use and | 2 | | |
| | | | | | | enjoyment | | | |
| | | | | | | of leased | | | |
| | | | | | | property | | | |
| Communal | 2 | Communal | 1 | Community | 1 | To act with | 1 | To refrain | 1 |
| | | | | Member | | force in | | from | |
| | | | | | | self- | | harming | |
| | | | | | | defense | | others | |
| | | | | | | | | except in | |
| | | | | | | | | self- | |
| | | | | | | | | defense | |
| | | | | | | | | To | 2 |
| | | | | | | | | minimize | |
| | | | | | | | | harm when | |
| | | | | | | | | acting in | |
| | | | | | | | | self- | |
| | | | | | | | | defense | |
| Familial | 3 | Parental | 1 | Parent | 1 | Conditional | 1 | To support | 1 |
| | | | | | | right to | | child | |
| | | | | | | receive | | | |
| | | | | | | support | | | |
| | | | | | | from major | | | |
| | | | | | | child | | | |
| | | | | Child | 2 | To receive | 1 | Conditional | 1 |
| | | | | | | support | | obligation | |
| | | | | | | | | of major | |
| | | | | | | | | child to | |
| | | | | | | | | maintain | |
| | | | | | | | | parent in | |
| | | | | | | | | need | |
| Governmental | 4 | Citizen- | 1 | Citizen | 1 | To receive | 1 | To pay | 1 |
| | | State | | | | social | | taxes | |
| | | | | | | security | | | |
| | | | | State | 2 | To receive | 1 | To provide | 1 |
| | | | | | | taxes | | social | |
| | | | | | | | | security | |

With reference to Tables 1 and 2 above, a natural major person entity could be described using a two-dimensional entity vector (1,2) whereas a motor vehicle entity could be described as the entity vector (0,18).

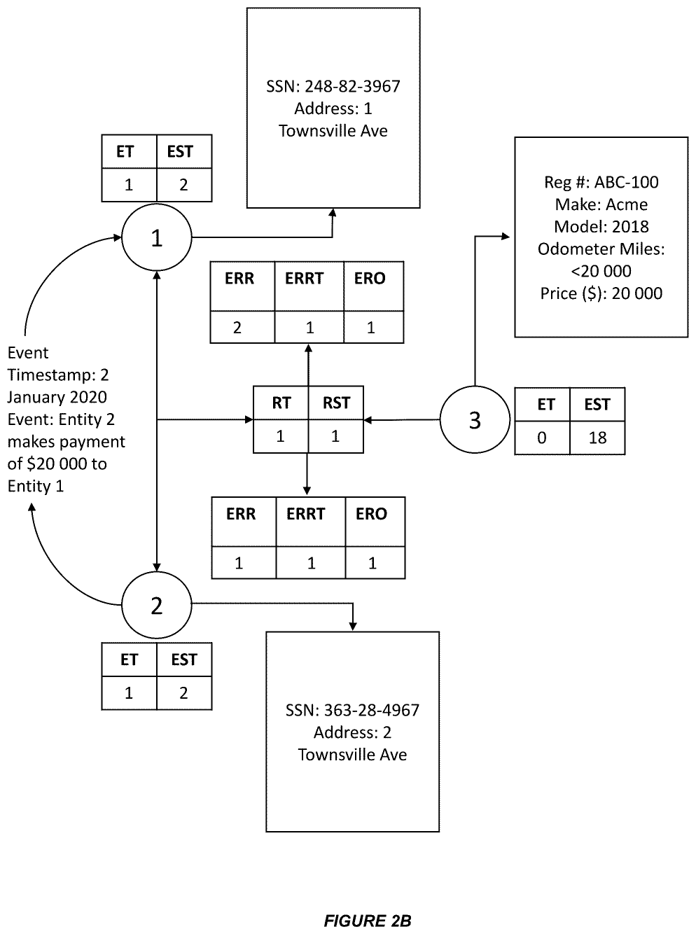

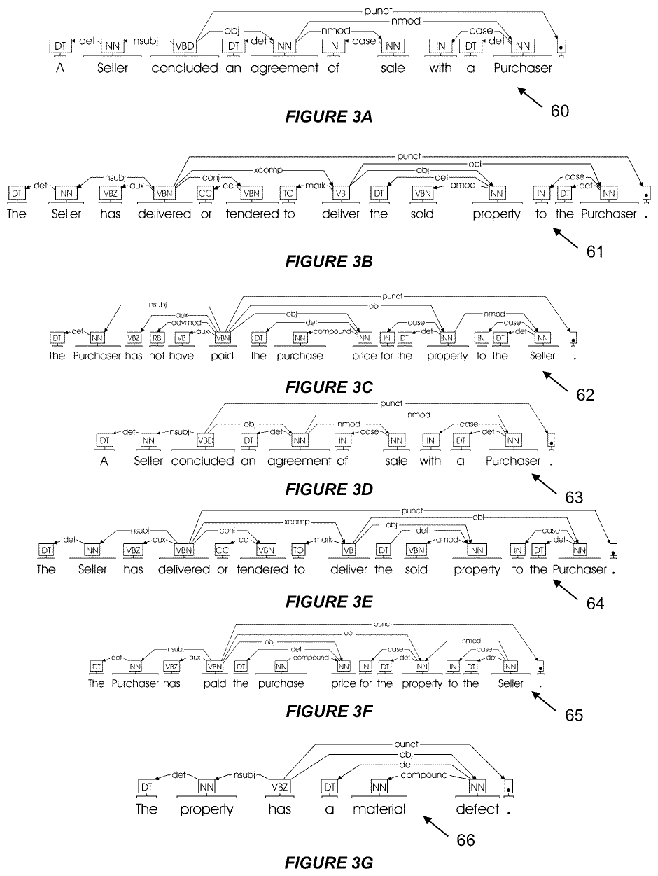

FIG. 2A shows a generic representation of a sale contractual relationship between Entity 1 and Entity 2 where Entities 1 and 2 could be any type of legal person, where the subject of the sale (Entity 3) is any type of non-legal person entity or object and where Entity 1 has the right to receive payment of the Entity 3 purchase price from Entity 2 and where Entity 1 is obliged to deliver Entity 3 as the sold item to Entity 2.

FIG. 2B shows a representation of a contractual relationship between Entity 1 and Entity 2 where: Entity 1 and 2 are both natural person majors, where each of Entity 1 and Entity 2 have the attributes of particular social security numbers and addresses, where Entity 3 is a motor vehicle with attributes of make, model, registration number, odometer distance and price, where the sale contract relationship gave rise to a relational obligation of Entity 2 to make payment of the purchase price of $20 000 to Entity 1 and where Entity 2 has made payment of the amount of $10 000 to Entity 1.

Embodiments of the system and method described herein may include one or more of: i) modelling, and/or utilizing a classification model for an entity-relational rules-based system based on sets of conditional and logical assertions that may be expressed and represented in coded formants, including binary or non-binary code formats, and including as embedded node paths in graphed data structures for processing and/or querying by devices that may form part of a network; ii) modelling, and/or utilizing a classification model of the relationships that may arise between entities within an entity-relational rules-based system, including the roles, rights and/or obligations that may be held by such entities within such relationships; iii) modelling, and/or utilizing a classification model for particular causes of action that may arise between natural or juridical entities within an entity-relational rules-based system and, in some embodiments, the remedies associated with such actions; iv) modelling and/or utilizing a classification model for specific elements that are necessary to sustain a particular cause of action within an entity-relational rules-based system.

Such models may be stored and maintained in, and accessible from, a database (which may include an entity-relational database or, in an exemplary implementation, a graph database or a combination of databases including entity-relational and/or graph databases). The models may take the form of, or be embodied in, any suitable data structures. For example, in some embodiments, the database may include a set or other collection of predefined conditions against which a set of data elements may be evaluated by the system and method described herein against specified thresholds or proximity measures. In some embodiments, each set of predefined conditions may relate to a cause of action that may arise between entities in a legal system. The collection of predefined conditions in some embodiments may therefore define all sets of legal actions or claims that may arise between entities in a legal system. Each predefined set of conditions may be associated with its own recognized sets of necessary factual data elements (being required data elements or necessary data elements) for identification in a set of data elements processed by the system and method described herein. Detection of a predefined set of conditions being met may, for example, require identification of the required data elements associated with that predefined set of conditions within a given set of data elements in accordance with specified thresholds or proximity measures.

In embodiments of the present disclosure, information may be accessed, processed and classified into models and other suitable data structures for the purposes of training and/or utilizing a machine and/or neural network (which may include a system of machines and/or neural networks) to extract, classify and/or identify, from the set of data elements one or more of: different entities; the existence of different types of relationships between those and other entities; the nature of those relationships; the roles occupied by entities within those relationships and/or the rights and/or obligations of those entities in relation to other entities; and other facts.

Extracting, classifying and/or identifying facts may include extracting, classifying and/or identifying data elements indicative of facts, the presence or absence of which are indicative of a particular predefined set of conditions having been met (e.g., in some embodiments, being indicative of the existence of a particular cause of action within a particular entity-relational rules-based system and/or being indicative of the existence or absence of the aforementioned facts which are indicative of the cause of action).

The models or other suitable data structures may be configured for querying and use in identifying or anticipating specific data elements within a set of data elements for identification of an associated predefined set of conditions having been met (e.g., in so far as being able to establish a cause of action from the facts represented by the data elements). Identification of an associated predefined set of conditions may be output together with a relative scale of probabilities or proximity measures.

Aspects of the present disclosure may further provide for pseudonymizing entity identities within or across the data elements, for example, to avoid information relating to an identified natural or juridical entity to be merged into one data location, moved between data locations, or otherwise transferred across a data network.

The system and method described herein may find particular application in rules-based systems requiring a high degree of detailed information analysis and a high degree of protection to be applied to the information to be so analyzed.

FIG. 1B is a flow diagram which illustrates an example embodiment of a method for building an entity-type classifier according to aspects of the present disclosure.

The method may include classifying (52) types of legal entities that may exist within a legal system using selected entity classifiers. This may include distinguishing (53) entities with legal persona from entities without legal persona; and/or distinguishing (54) fungible entities from non-fungible entities. The method may include training an entity-type classifier based on the classifications and distinctions and outputting (56) the entity-type classifier based on the classifications. The training may use a corpus of a number of different corpora of information, for example being contained in a training database (including, e.g., a knowledge base and a precedent base).

FIG. 1C is a flow diagram which illustrates an example embodiment of a method for building an entity-relational model according to aspects of the present disclosure.

The method may include classifying (70) types of relationships that may arise between entities in the relevant rules-based system. Classifying types of relationships may include training and outputting (72) an entity-relationship classifier which, when trained to a sufficient degree, identifies and labels types of relationships existing between entities identified, for example, using an entity-type classifier. Classifying types of relationships may include, for each relationship type, classifying (76) the types of roles, rights and/or obligations that may be held by entities occupying such relationships in relation to other entities. Classifying types of relationships may include training and outputting (78) an entity-role, rights and/or obligations classifier which, when trained to a sufficient degree, identifies and labels roles, rights and/or obligations associated with entities in relationships identified, for example, using an entity-type classifier and/or an entity-relationship classifier. The training may use a corpus of information, for example being contained in a training database (including, e.g., a knowledge base and a precedent base).

The method may include creating a relationship-type data structure for each type of relationship. The relationship-type data structure may be any suitable data structure or collection of data structures that describe attributes of the relevant type of relationship as defined by the relevant rules-based system. The relationship-type data structure for each type of relationship may include attributes of the relationship, including one or more of: an entity role in the relationship; an entity right in the relationship; and/or an entity obligation in the relationship. Relationship types may be further categorized into relationship sub-types, and so on. In some embodiments, each entity-type data structure may be a model of the relevant relationship type.

The method may further include defining (80) necessary elements or conditions associated with a cause of action in terms of the rules of the system. Each of the one or more necessary elements may be associated with a condition expressed (82) using entity, relationship, role, rights and/or obligation classifiers. The necessary elements may represent features required to be present in a state data structure for the occurrence of a condition to be established. The method may include storing (84) the expressed conditions in a rules base in a selected data format.

In some embodiments, the rules base may include remedies available to an entity where certain conditions arise. Although it is not strictly necessary, risk events or causes of action may be grouped into sub-types based on categories and sub-categories of the risks or actions themselves.

It should be noted that embodiments may be provided in which not all of the types of entities, relationships and roles that may arise in the entity-relational rules-based system are classified. In some embodiments, a subset or selection of entities, relationships, conditions, and the like may be provided for. Such embodiments may provide a relationship type-specific (or relationship types-specific) system and method for machine-learning based identification of a condition. In some cases, for example, priority risks events may be prioritized, and the system and method may be extended to other events over time. Such an approach may be recommended given the relative significance and importance of the accuracy of the outputs of a system trained using the method described herein and the amount of training that may be required to be performed during the learning process for the outputs to become reasonably or increasingly accurate.

Table 3, below, contains a natural language representation of the elements necessary to sustain two different causes of action for payment of the purchase price and for refund of the purchase price in relation to corporeal property sold and delivered in a hypothetical legal system. Purely for illustration purposes, classification of such an action within a traditionally recognized branch of law is also shown.

TABLE 3

| Category | Category | Cause of | Action | |
|---|---|---|---|---|
| of Law | Sub-Sub-Type | Action | Sub-Type | Necessary Elements |
| Contract | Sale Contract > | Breach of | Action for | “A Seller concluded an agreement of |
| Law | Sale of Corporeal | Contract | payment of | sale with a Purchaser.” (60) |
| | Property > Non-Fungible | | purchase price | “The Seller has delivered or tendered |
| | | | | to deliver the sold property to the |
| | | | | Purchaser.” (61) |
| | | | | “The Purchaser has not have paid |
| | | | | the purchase price for the property to |
| | | | | the Seller.” (62) |
| Contract | Sale Contract > | Breach of | Action for | “A Seller concluded an agreement of |
| Law | Sale of Corporeal | Contract | refund of | sale with a Purchaser.” (63) |
| | Property > Non-Fungible | | purchase price | “The Seller has delivered or tendered |
| | | | | to deliver the sold property to the |
| | | | | Purchaser.” (64) |
| | | | | “The Purchaser has paid the |
| | | | | purchase price for the property to the |
| | | | | Seller.” (65) |
| | | | | “The property has a material defect.” |
| | | | | (66) |

It should be noted that where the rules and the facta probanda associated with those rules utilize natural language in their original forms of expression, those natural language words used in the expression of the rules and the facta probanda are likely to contain many linguistic synonyms and to be capable of expression in multiple different ways, including active or passive formulations, using different tenses and word orderings without affecting their meaning.

The method may include parsing and labelling necessary elements associated with the relationship-type data structure.

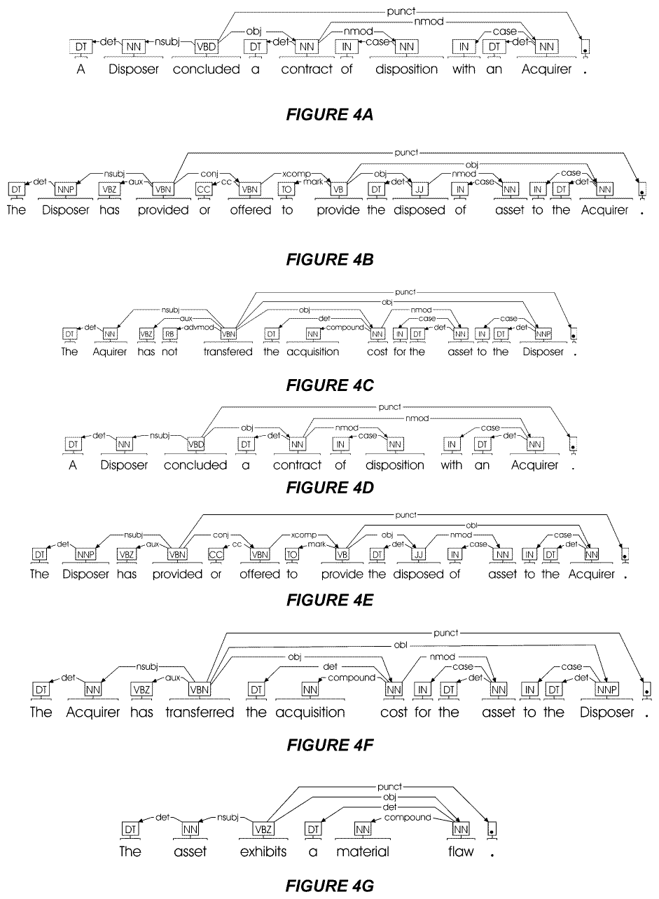

For example, FIGS. 3A-3G schematically illustrate example representations of parsing and tagging (or labelling) natural language expressions of the example necessary elements described above in Table 3. FIGS. 3A-3G show the necessary elements for the two simple hypothetical examples of two different causes of action for payment of the purchase price (60-62) and for refund of the purchase price (63-66) in relation to property sold and delivered in a hypothetical legal system, with the necessary elements having been parsed and labelled for entity recognition, part-of-speech and grammatical dependencies. The parsing and labelling may be implemented using any suitable techniques and frameworks, such as is shown in the example representations of FIGS. 3A-3G where the Penn Treebank part of speech tag set and the Universal Dependencies framework has been used.

The method may therefore include obtaining (for example including generating) a series of semantically equivalent phrases relating to each of the necessary elements of a cause of action type. The method may include parsing and labelling the series of semantically equivalent phrases.

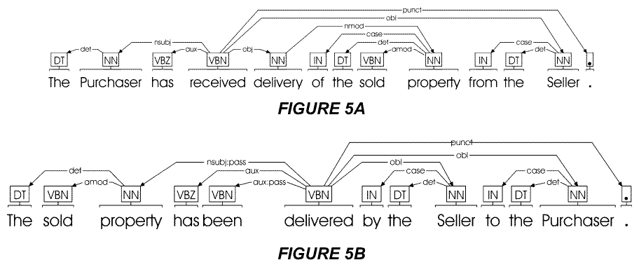

FIGS. 4A to 4G schematically illustrate example representations of parsing and tagging the series of equivalent phrases in which: the phrase in FIG. 4A is semantically equivalent to the phrasing of the necessary element illustrated in FIG. 3A; the phrase in FIG. 4B is semantically to the phrasing of the necessary element illustrated in FIG. 3B; the phrase in FIG. 4C is semantically to the phrasing of the necessary element illustrated in FIG. 3C; the phrase in FIG. 4D is semantically to the phrasing of the necessary element illustrated in FIG. 3D; the phrase in FIG. 4E is semantically to the phrasing of the necessary element illustrated in FIG. 3E; the phrase in FIG. 4F is semantically to the phrasing of the necessary element illustrated in FIG. 3F; and, the phrase in FIG. 4G is semantically to the phrasing of the necessary element illustrated in FIG. 3G. The examples in FIGS. 4A to 4G illustrate revised representations of the necessary elements illustrated in FIGS. 3A to 3G in which word synonyms have been used to create two alternative, but semantically equivalent, representations of each necessary element. Part of speech tags indicate that the grammatical structures of the two alternative representations are identical.

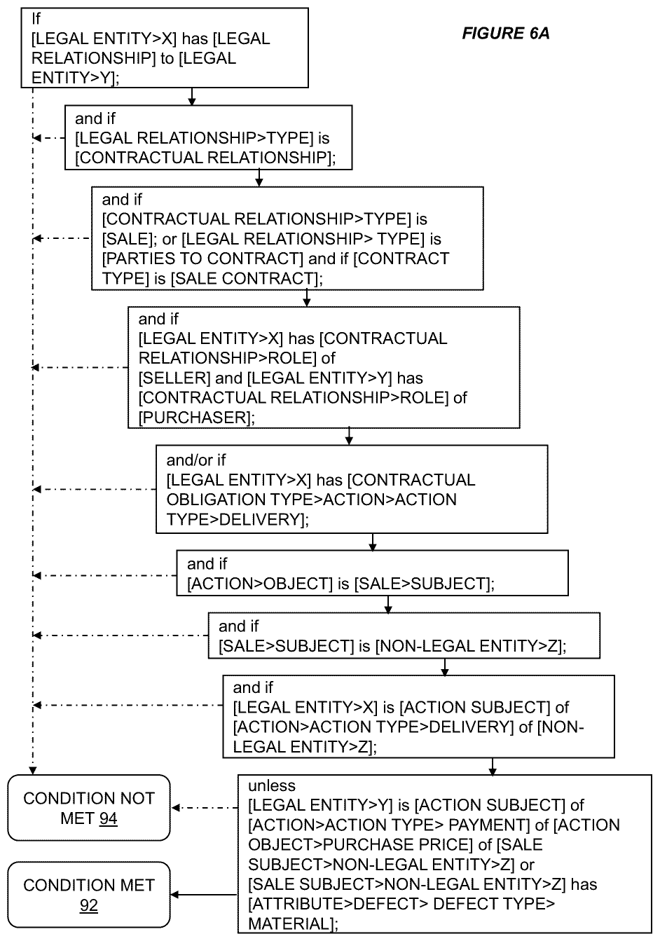

FIGS. 5A and 5B schematically illustrate example representations of parsing and tagging two phrases which are semantically equivalent to the phrase illustrated in FIG. 3B, but in which different grammatical voices and structures are used.

In some embodiments, rules of the rules-based system may be formulated in natural language conditions and natural language content may be processed for the detection of facts that correlate with risk events or causes of action arising in terms of those rules. Such embodiments may cater for representations and formulations of the relevant facta probanda in all or as many possible voices (i.e., both in active voice, where the subject performs the action, e.g., Entity X made payment to Entity Y, and in the passive voice, where the subject receives the action, e.g., Entity Y received payment from Entity Y) and tenses. Such embodiments may be configured for using multiple potential combinations of word orderings and word synonyms so as to enable correlations between processed facts and the relevant facta probanda to be identified in as wide a range of natural language circumstances as possible using the system and method described herein.

In some embodiments, part-of-speech tagging may be applied to expressions of the rules. Further, word-matching algorithms may be utilized to identify potential synonyms for words used within the same “part of speech” or grammatical setting or role so as to generate and build out additional alternative semantically equivalent representations of the rules as possible. In an exemplary embodiment, word and/or phrase embeddings in the form of semantic vector space models may be utilized to enable recognition of different semantic representations of equivalent facts, expressions of rules and/or circumstances. Such embeddings may be generated by neural network, co-occurrence, probabilistic and other methods using pre-trained algorithms and/or, in an exemplary embodiment, using neural network techniques such as the Word2vec algorithm trained on specialized domain corpora such as, in the case of a legal system, published law reports, textbooks and evidential materials.

The method may include classifying information contained in the data elements by utilizing information processing and information extraction tools to process training corpora for entity recognition and fact extraction, including entity attribute extraction, entity relationship extraction, object extraction, action extraction and event extraction. The method may include parsing and labelling the extracted information using the same ontological framework used to express the system's rules as sets of conditional-if statements and logical assertions.

In some embodiments, the method may include defining a schema which represents the necessary elements of each relationship-type data structure in a logical format. For example, the schema may represent the necessary elements as a series of conditionals (e.g., being conditional statements, expressions, constructs, etc.). The conditionals may be if statements, if-then statements, if-then-else statements, or the like. The conditionals may be suitable programming language commands or representations for handling decisions, which in the embodiments described herein relate to whether or not a condition has occurred.

Thus, with regard for the different types of relationships that may arise between entities, the nature of those relationships, the roles that may be occupied by the entities within those relationships and the rights and obligations of the entities associated with such roles, a set of logical rules or conditions may be defined for a cause of action of any particular type or sub-type to arise. For example, defining the schema may include codifying rules of the entity-relational rules-based system for determining whether a cause of action has arisen between two or more entities based on the necessary elements or facta probanda for any such action to arise.

Using the ontological elements of the model described above, such codifying may include expressing the sets of facta probanda for particular causes of action to arise between two or more entities as logical conditions that must be true for any such cause of action to arise between said entities. The logical conditions may be arranged serially and may for example represent a threshold against which features or data elements of the state data structure may be evaluated for identifying occurrence of the condition. For example, it is possible to express conditions using a variety of natural or computer programming languages, logical or query operators and condition expression structures.

The schema may be arranged to give expression to the logical conditions of the rules using ontological elements that may be readily correlated with the ultimate layer of outputs of data classification processes (e.g., as contained in the state data structure). The various representations of the rules or facta probanda may thus be reduced to a logical programming format. For example, the method described herein may implement ontological element tokenization and natural language operators for representation of entity identifiers and/or required data elements.

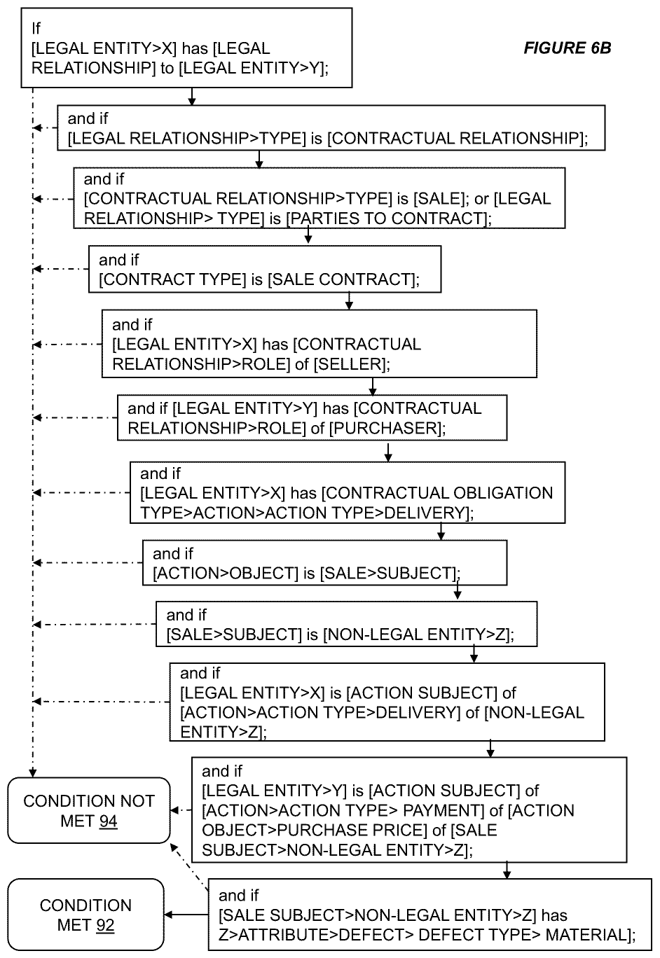

FIGS. 6A and 6B are schematic representations for two example conditions in which necessary elements of the respective conditions are encoded as a series of conditionals. The examples in FIGS. 6A and 6B use natural language pseudocode and regular operators such as “has” or “is” are used to indicate conditions that, if true, would result in a legal entity “X” either having a claim for payment against another legal entity “Y” in relation to an item of property “Z” sold to “Y”; or else, having an outstanding contractual obligation to deliver the item of property “Z” to the legal entity “Y”.

In FIGS. 6A and 6B, broken lines are used to indicate a logical path that is taken if the relevant conditional is not met, while solid lines are used to indicate a logical path that is taken if the relevant conditional is met. The Figures illustrate a series of conditionals (illustrated using rectangular blocks with sharp corners) that need to be met before occurrence of a condition would be identified or established from a set of features contained in state data structure.

In FIG. 6A, the necessary elements for an example condition, being an “action for payment of purchase price”, are illustrated. The action may be a subtype of a set of actions in the “sale of property” subtype, which in turn may be a subtype of a set of actions in the type “breach of contract”. The necessary elements are encoded as conditionals such that features of a state data structure can be evaluated for occurrence of the condition, in this case being an “action for payment of purchase price” in terms of a contract of sale between the entities.

In FIG. 6B, the necessary elements for an example condition being an “action for refund of purchase price” is illustrated. The action may be a subtype of a set of actions in the “sale of property” subtype, which in turn may be a subtype of a set of actions in the type “breach of contract”. The necessary elements are encoded as conditionals such that features of a state data structure can be evaluated for occurrence of the condition, in this case being an “action for refund of purchase price” in terms of a contract of sale between the entities.

In both Figures, the following conditionals are required to be met in order to establish that legal entity “X” may be recognized to have a legal obligation to sell and deliver property “Z” to another legal entity “Y”:
[LEGAL ENTITY>X] has [LEGAL RELATIONSHIP] to [LEGAL ENTITY>Y]; and [LEGAL RELATIONSHIP>TYPE] is [CONTRACTUAL RELATIONSHIP]; and [CONTRACTUAL RELATIONSHIP>TYPE] is [SALE]; or [LEGAL RELATIONSHIP>SUB-TYPE] is [PARTIES TO CONTRACT>CONTRACT TYPE>SALE]
[LEGAL ENTITY>X] has [CONTRACTUAL RELATIONSHIP>ROLE] of [SELLER]; and [LEGAL ENTITY>Y] has [CONTRACTUAL RELATIONSHIP>ROLE] of [PURCHASER]; and [LEGAL ENTITY>X] has [CONTRACTUAL OBLIGATION TYPE>ACTION>ACTION TYPE>DELIVERY] and [ACTION>OBJECT] is [SALE>SUBJECT]; and [SALE>SUBJECT] is [NON-LEGAL ENTITY>Z].

Similarly, and referring now to FIG. 6A, an action for “breach of contract” of sale with a legal action sub-type of “action for payment of purchase price” for property sold may be recognized to arise (i.e., a condition may be identified) where all of the above conditions are satisfied and where the following elements can also be proven or be deduced to be true:
[LEGAL ENTITY>X] is [ACTION SUBJECT] of [ACTION>ACTION TYPE>DELIVERY] of [NON-LEGAL ENTITY>Z]
   provided both of the following conditions are false:
[LEGAL ENTITY>Y] is [ACTION SUBJECT] of [ACTION>ACTION TYPE>PAYMENT] of [ACTION OBJECT>PURCHASE PRICE] of [SALE SUBJECT>NON-LEGAL ENTITY>Z] and
[SALE SUBJECT>NON-LEGAL ENTITY>Z] has [ATTRIBUTE>DEFECT>DEFECT TYPE>MATERIAL]

By contrast, and referring now to FIG. 6B, the action sub-type of “action for refund of purchase price” to Y for the property sold by X will arise where both of the following conditions can be proven or be deduced to be true:
[LEGAL ENTITY>Y] is [ACTION SUBJECT] of [ACTION>ACTION TYPE>PAYMENT] of [ACTION OBJECT>PURCHASE PRICE] of [SALE SUBJECT>NON-LEGAL ENTITY>Z] and
[SALE SUBJECT>NON-LEGAL ENTITY>Z] has Z>ATTRIBUTE>DEFECT>DEFECT TYPE>MATERIAL].

The schema may define that the conditionals are evaluated in series (e.g., being one after the other) provided the preceding conditional is met. The conditionals may be traversed by evaluating features of a state data structure against each conditional in turn to determine, based on the series of evaluations using appropriate features, whether the condition is met (92) or not met (94). Each conditional may define features of the state data structure which are required for evaluation of the conditional such that, when executed, a given conditional instructs retrieval of relevant features for evaluation in terms of the conditional.

While it is customary in some legal systems to expressly identify both the formation of a contractual relationship and the existence of certain contractual rights and obligations, if a contractual right or obligation has been correctly identified, it is implied that a contractual relationship must exist. This in turn may imply that if a contractual right or obligation condition is accurately verified, such verification may be taken to satisfy the condition that a contractual relationship exists without independent express verification of the existence of the contractual relationship.

The method may include storing one or more of the classifiers, relationship-type data structures (including associated schemas, conditionals and the like) as an entity-relational model for access and use in evaluating data elements for occurrence of one or more conditions.

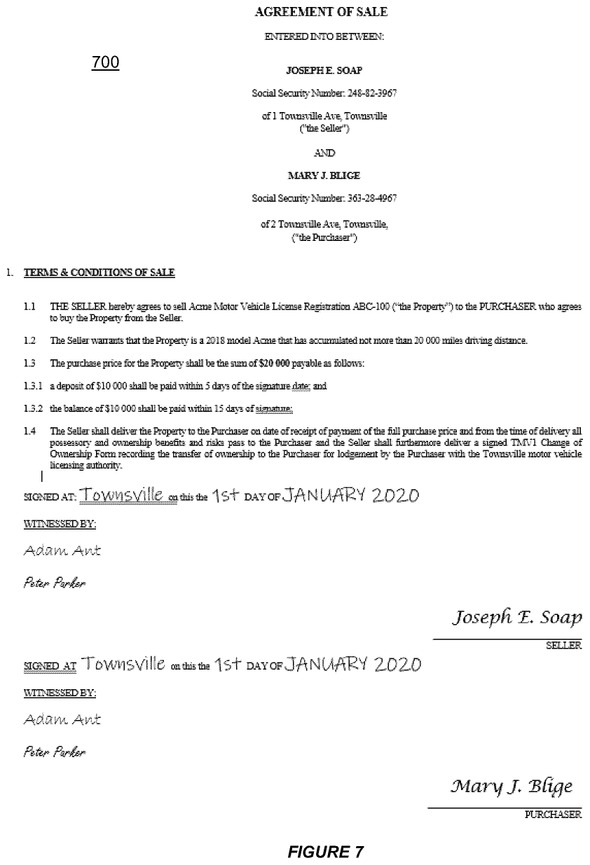

An example implementation of the method described above with reference to FIG. 1D and FIG. 2B1 is now described with reference to an example artifact (700), being the document representing a contract illustrated in FIG. 7. In what follows, simple examples of hypothetical legal system domain customized labelling “or tagging” being applied to the document as well as examples of certain elements within the document being tagged at different macro-composite (holistic) and micro-constituent levels using selected system relevant classification trees of different depths.

Data elements may be received (10), which in this example embodiment may include receiving the artefact (700) and then labelling the artifact with a unique identifier and converting the artefact into a set of data elements (e.g., using optical character recognition, in the case of this exemplary artefact). The entire artefact at a macro-level may be recorded in an artefact register, assigned a unique artefact identifier and be classified as a [CONTRACT] with [UNIQUE CONTRACT IDENTIFIER #].

The artefact could potentially be given further classifications of [CONTRACT TYPE>SALE] amongst others and classifications could be applied at multiple different macro-composite or micro-constituent labelling levels.

The data elements recognized and extracted from the artefact may then be processed (12). For example, [1 Jan. 2020] would be recognized as a [CO-ORDINATE] with [CO-ORDINATE TYPE>TIME] and [TIME VALUE>20200101] and all of the information grouped and contained within the entire signature section of the contract could also be macro-level registered as an [EVENT] where [EVENT TYPE] is [ACTION>ACTION TYPE>SIGNATURE] and where [ACTION SUBJECT] is [UNIQUE CONTRACT IDENTIFIER #] and where [EVENT>TIME CO-VALUE] is [20200101].

[ACME MOTOR VEHICLE] could be recorded, registered and/or classified as an [ENTITY>NON-LEGAL ENTITY>CORPOREAL>NON-FUNGIBLE>TYPE>MOTOR VEHICLE] with [MOTOR VEHICLE ATTRIBUTE>MILES TRAVELLED>20000] as well with [MOTOR VEHICLE ATTRIBUTE>LICENSE REGISTRATION NUMBER>ABC-100] and also as the [OBJECT] of the [OBLIGATION>ACTION>ACTION TYPE>DELIVERY] owed by [JOSEPH E. SOAP] as [ACTION SUBJECT] of the [OBLIGATION>ACTION>ACTION TYPE>DELIVERY] and/or as the [OBJECT] of the [ACTION>ACTION TYPE>PURCHASE] made by [MARY J. BLIGE] as [ACTION SUBJECT] of the [ACTION>ACTION TYPE>PURCHASE].

[$20 000] could be classified as a [QUANTUM] with [QUANTUM TYPE>MONETARY VALUE>MONETARY TYPE>US DOLLARS>VALUE>20000] as well as being recorded, registered and/or classified as the [OBJECT ATTRIBUTE>PRICE] of the [OBJECT] of the [ACTION>ACTION TYPE>SALE] made by [JOSEPH E. SOAP] as [ACTION SUBJECT] of the [ACTION>ACTION TYPE>SALE] and/or as the [OBJECT ATTRIBUTE>PRICE] of the [OBJECT] of the [ACTION>ACTION TYPE>PURCHASE] made by [MARY J. BLIGE] as [ACTION SUBJECT] of the [ACTION>ACTION TYPE>PURCHASE] and finally as the [OBJECT] of an [OBLIGATION>ACTION>ACTION TYPE>PAYMENT] where [MARY J. BLIGE] is the entity associated as the [SUBJECT] of [OBLIGATION>ACTION>ACTION TYPE>MAKE PAYMENT] and [JOSEPH E. SOAP] is the [SUBJECT] of [RIGHT>ACTION>ACTION TYPE>RECEIVE PAYMENT].

[JOSEPH E. SOAP] and [MARY J. BLIDGE] could each be recorded, registered and/or classified as an [ENTITY>ENTITY TYPE>LEGAL ENTITY>LEGAL ENTITY TYPE>NATURAL LEGAL ENTITY>NATURAL ENTITY TYPE>MAJOR ENTITY]. [JOSEPH E. SOAP] would further be assigned [ENTITY ATTRIBUTE>NAME>JOSEPH E. SOAP] as well as [ENTITY ATTRIBUTE>SOCIAL SECURITY NUMBER>248-82-3967] and [MARY J. BLIDGE] would further be assigned [ENTITY ATTRIBUTE>NAME>MARY J. BLIGE] as well as [ENTITY ATTRIBUTE>SOCIAL SECURITY NUMBER>363-28-4967].

[JOSPEH E. SOAP] could be relationally linked to [MARY J. BLIGE] with a [RELATIONSHIP TYPE] of [CONTRACTUAL RELATIONSHIP] and [MARY J. BLIGE] recorded as having a [CONTRACTUAL RELATIONSHIP>OBLIGATION] to take an [ACTION] with [ACTION TYPE>PAYMENT] where [ACTION>OBJECT] is also the [ACTION>OBJECT] of the [ACTION>ACTION TYPE>PURCHASE] made by [MARY J. BLIGE] of the [ENTITY>NON-LEGAL ENTITY>CORPOREAL>NON-FUNGIBLE>TYPE>MOTOR VEHICLE] with [MOTOR VEHICLE ATTRIBUTE>MILES TRAVELLED>20000] as well with [MOTOR VEHICLE ATTRIBUTE>LICENSE REGISTRATION NUMBER>ABC-100].

After applying the training labels to the above documents, the following information would be known or deductible and compiled into a state data structure:
[LEGAL ENTITY>##248-82-3967] has [LEGAL RELATIONSHIP] to [LEGAL ENTITY>#363-28-4967];
[LEGAL RELATIONSHIP>TYPE] is [CONTRACTUAL RELATIONSHIP];
[CONTRACTUAL RELATIONSHIP>TYPE] is [CONTRACT OF SALE]; or [LEGAL RELATIONSHIP>SUB-TYPE] is [PARTIES TO CONTRACT>SALE];
[LEGAL ENTITY>[##248-82-3967] has [CONTRACTUAL RELATIONSHIP>ROLE] of [SELLER];
[LEGAL ENTITY>#363-28-4967] has [CONTRACTUAL RELATIONSHIP>ROLE] of [PURCHASER];
[SALE>SUBJECT] is [ENTITY>NON-LEGAL ENTITY>CORPOREAL>NON-FUNGIBLE>TYPE>MOTOR VEHICLE] with [MOTOR VEHICLE ATTRIBUTE>MILES TRAVELLED>20000] as well with [MOTOR VEHICLE ATTRIBUTE>LICENSE REGISTRATION NUMBER>ABC-100]
[SALE SUBJECT>PRICE] of [UNIQUE CONTRACT IDENTIFIER] is [MONETARY VALUE>MONETARY TYPE>US DOLLARS>US DOLLAR SUM>20000].

Such a state data structure could be evaluated for occurrence of a condition.

At some point, further data elements may be received (20). For example, an email may be received with text as follows:
To: Joseph E. Soap
From: Mary J. Blige
Date: 2 Jan. 2020
Subject: Purchase of Motor Vehicle Registration Number ABC-100
Dear Joe,
Please find enclosed herewith proof of payment of the sum of $20 000 being payment of the purchase price for the above property.
Kindly acknowledge receipt hereof.
Mary.

Data elements may be extracted from the email and processed (12) such that [Mary J. Blige] could be recognized and classified as [ENTITY>#363-28-4967] and Joseph E. Soap could be recognized as [ENTITY>#248-82-3967].

This email could be tagged holistically as one entity artefact that is itself evidence of an “action” (or alternatively “an event”) where:
[EVENT>TYPE] is [ACTION];
[ACTION>TYPE] is [PAYMENT];
[ACTION>TIME CO-ORDINATE VALUE] is [20200102].
[ACTION>SUBJECT] is [ENTITY>#363-28-4967];
[ACTION>OBJECT] is [SALE SUBJECT>PRICE] of [UNIQUE CONTRACT IDENTIFIER].

Therefore, in light of the event of 2 Jan. 2020, [LEGAL ENTITY>##248-82-3967] would not have any right to institute an action for payment of the purchase price (i.e., the sale subject consideration) for this contract as the following known “event” information:
[ACTION>DATE] is [2 Jan. 2020]
[ACTION>TYPE] is [PAY]
[ACTION>SUBJECT] is [ENTITY>#363-28-4967];
[ACTION>OBJECT] is [SALE SUBJECT>PRICE] of [UNIQUE CONTRACT IDENTIFIER #];
   means that the following condition would not be false for this contractual relationship after 2 Jan. 2020:
[LEGAL ENTITY>#363-28-4967] is [ACTION SUBJECT] of [ACTION>ACTION TYPE>PAY] and [ACTION>OBJECT] is
[SALE SUBJECT>PRICE] of [SALE>SUBJECT] of [UNIQUE CONTRACT IDENTIFIER]
   and it would need to be false for such a cause of action to arise terms of the rules expressed in the example tables contained Table 2.

As mentioned above, in some embodiments, entity identifiers may be pseudonymized for privacy and/or security reasons. For example, in order to achieve the utility benefit of identifying or anticipating (based on elements, sets or corpora of data), whether a cause of action has arisen, or may arise, in relation to one or more entities subject to an entity-relational rules-based system, without human review and without causing information relating to an identified natural or juridical entity to be merged into one data location, moved between data locations, or otherwise transferred across a data network, it may be necessary to introduce a process for pseudonymizing entity identities within or across corpora of information that itself does not cause information relating to an identified natural or juridical entity to be merged into one data location, moved between data locations, or otherwise transferred across a data network.

Aspects of the present disclosure may therefore include assigning pseudonymized identifiers to entities referenced within processed corpora of information. This may be implemented, in an exemplary embodiment, using a federated data processing system, or other database systems, and using a number of different approaches. One such way is to create a pseudonymized value “register” of all extracted entities by applying a deterministic pseudonymizing algorithm to an entity item at the information point at which the entity has been extracted.

The term “pseudonymized” is used herein to describe entity data that has been obfuscated but which can be re-identified, or associated, with that entity. “Pseudonymized” data should not be understood as excluding “encrypted” data. Pseudonymized data contrasts theoretically with so-called “one-way” anonymized data which “cannot” be linked back to the entity with which it corresponds. At the time of writing, it is probably best to adopt an approach to information security where no information security technique can be regarded as offering an absolute guarantee against breach.

In an exemplary embodiment, the problem of creating more than one separate value for entities known by more than one name or by more than one spelling of that name can be mitigated by sending entity names to an entity register for co-referencing standardization purposes and by passing the standardized name, or a pseudonymized version of that name, back to the information store from which the entity name was extracted.

Once entity names have been pseudonymized, further data about those entities is extracted from the corpora located on specific disks or devices and extracted data elements linked to pseudonymized entity identifiers are pooled into either a centralized or federated database system.

As a result of this technique, only pseudonymized entity identities linked to facts, attributes or relationship counterparty identities are passed across a network in the composition of the centralized or federated database. In some embodiments, non-legal entity names may be pseudonymized as well.

A descriptive example is provided below dealing with entity referencing and the assignment of pseudonymized identifiers to entities. For convenience, examples have been chosen where co-reference resolution steps would not be required for the named entities and key objects concerned by using examples of entity identities of a type that may have typically been registered with unique entity identifiers in a system that the implementor of this method is presumed, for the sake of the example, to have access to a fungible object (medical drug) that may be assumed to be qualitatively indistinguishable from others of the same type, but an ideal embodiment would cater for co-referencing resolution of named entities and other objects, including non-fungible objects in particular.

### Example

On 1 Jan. 2022, one John Smith, of New York, New York, visits a Dr Morpheus, Unique Physician Identification Number (UPIN) 1234567890. Upon his arrival at Dr Morpheus practice, John fills out a patient registration form. The information could be submitted into the form by means of a tablet device linked to Dr Morpheus' patient management system or the information could be submitted on paper and later captured into the same patient management system by Dr Morpheus' practice assistant.

John Smith provides, inter alia, the following information in the patient registration form:
Social Security Number: 123456789
Mobile telephone number (MSISDN): +1 234 567 8901
Email address john.smith@acmecorp.com
Medical Costs Insurer: Medsureco Inc

John dislikes filling out forms and leaves a number of form fields incomplete. For example, he skips over the section asking him to list any allergies that he may have.

John ticks a check box that says his personal data and medical information may be shared by his doctor with his own medical costs insurer. The patient management system associates Medsureco Inc with its Federal Insurance Provider License Number 55555.

However, John declines to tick a further check box that says that his personal data including medical information may be shared with Dr Morpheus' own medical practice insurer Profsure Inc, as John regards this as excessive and unnecessary processing of his personal information.

A record is created in Dr Morpheus patient management system for John Smith as patient number #10101.

However, Profsure Inc requires Dr Morpheus's practice, as a condition of his policy, to submit anonymized patient personal and medical data to a risk management system used by Profsure.

Doctor Morpheus diagnoses John as suffering from an “Acute Upper Respiratory Bacterial Infection” from a list of possible diagnoses presented in the consultation window that he has opened in his patient management system for patient John Smith, #10101. The system codes this diagnosis using the International Classification of Diseases system as IDC-10 Code: J06.9.

Before prescribing any medication, Dr Morpheus takes extra care to ask John if he has any known allergies or has experienced adverse reactions to any medication. John advises Dr Morpheus that he is allergic to the drug Penicillin V Potassium. Dr Morpheus notes that down in his patient Management system record for John and the system records that John is allergic to that drug Using the National Drug Code (NDC) number 57237-040-01. Dr Morpheus then prescribes a Course of Azithromycin, NDC 50090-1646-0.

Data regarding the patient John Smith is encrypted before being transmitted to Profsure Inc. For example, John's social security number captured on Dr Morpheus's patient management system is encrypted using the standard public key encryption algorithm used by all subscribers to Profsure Inc's risk management system. Profsure Inc receives, inter alia, the following data package from Dr Morpheus' patient management system as passed via the anonymizing application embedded within the patient management system:
Insured Physician Entity UPIN: 1234567890
Patient Entity Social Security Number: xxxxxxxx
Physician Patient Reference No.: #10101
Patient Entity MSISDN: +yyyyyyyyyyy
Patient Entity Email Address: zzzzzzzzzz@zzzzzzzz.com
Patient Entity Drug Allergies: 57237-040-01
Consultation time: 2022-01-01 16:28:05
Diagnosis: J06.9
Prescribed Drug: 50090-1646-0

A doctor and patient relationship is recorded between the practitioner entity with UPIN 1234567890 and patient entity with social security number xxxxxxxx and Physician Patient Reference no. #10101. From the existence of this relationship, it is inferred from the domain knowledge base rules that entity yyyyyyyyy is owed a duty of care by entity UPIN 1234567890. Entity xxxxxxxx is also recorded as having an entity attribute of being allergic to NDC 57237-040-01. Such a collection of data elements may represent a state data structure.

Six months later, John Smith moves to Pittsburgh, Pennsylvania where he consults with a Dr Neo with Unique Physician Identification Number (UPIN) 1234567891. John Smith completes a patient registration form and provides the identical information that he provided to Dr Morpheus. John again declines to tick a box that says that his personal data and medical information may be shared with Dr Neo's medical practice insurer Profsure Inc. John also again omits to list any allergies on the patient registration form.

A record is created in Dr Neo's patient management system for John Smith as patient number #99999.

Dr Neo diagnoses John Smith as suffering from an acute upper respiratory bacterial infection.

However, Dr Neo omits to ask John Smith whether he is allergic to any medication before prescribing a course of Penicillin V Potassium.

Profsure Inc receives, inter alia, the following data package from Dr Neo's patient management system as passed via the anonymizing application plugged into the patient management system:
Insured Physician Entity UPIN: 1234567891
Patient Entity Social Security Number: xxxxxxxx
Physician Patient Reference No.: #99999
Patient Entity MSISDN: +yyyyyyyyyyy
Patient Entity Email Address: zzzzzzzzzz@zzzzzzzz.com
Patient Entity Drug Allergies:
Consultation date: 2022-07-01 16:28:05
Diagnosis: J06.9

### Prescribed Drug: 57237-040-01

The above data elements may constitute further data elements, and a doctor and patient relationship is recorded between the practitioner entity, with UPIN 1234567891, and patient entity with social security number, xxxxxxxx. The further data elements are processed, and the entity with coded social security number xxxxxxxx is now listed as occupying a patient role in two separate doctor and patient relationships, i.e., one with UPIN 1234567890 and one with UPIN 1234567891. From the existence of this second relationship, it is inferred from the general data model that entity xxxxxxxx is owed a duty of care by entity UPIN 1234567891. However it is also detected that entity UPIN 1234567891 has prescribed a drug to which entity xxxxxxxx is allergic, which has been coded as precedent example of certain facta probantia that indicate the existence of a breach of the duty of care between a doctor and patient (the facta probanda for a cause of action of clinical negligence) and a condition may be identified in the form of emergence of a set of circumstances and events that present a risk of harm to the patient and that do, or could, give rise to a legal claim against the insured entity with UPIN 1234567891 if patient entity xxxxxxxx suffers harm.

To mitigate the risk of harm to xxxxxxxx resulting from this breach, Profsure Inc's risk management system could be programmed to immediately decrypt the patient entity MSISDN number and to send a text message to John Smith's MSISDN advising him to immediately contact Dr Neo before taking any prescribed medication. A simultaneous message could be sent to Dr Neo alerting him to contact his patient with practice reference #99999 and notifying him of the prescribed medication being a type of drug to which the patient is known to be allergic.

In this way, the Profsure Inc risk management system is able to detect the emergence of a risk event and potential legal action for medical malpractice between an insured doctor and a particular patient and without any confidential personally identifiable information having been transferred across a potentially insecure data network. Profsure Inc would even be able to transmit a legal brief to its attorneys asking for an opinion on Dr Neo's legal liability for patient harm after prescribing a drug which a patient is allergic too but where that patient has failed to enter any known allergies in his patient registration form and an opinion on the merits of such a claim based on the relevant facts could be transmitted to Profsure Inc without any personal or other confidential and legally privileged information being transmitted across a potentially insecure data network.

In the example provided above, both Dr Morpheus and Dr Neo could host their own patient management system databases in different hosting locations. Anonymized information from their respective databases could be merged into a composite database held by their mutual insurer, or else their mutual insurer could perform queries against anonymized data held in their constituent databases.

The potential value of supplementing privately known or specific-device-extracted corpus data about entities with other generally known data about the same entities should be clear, even though it may not always prove to be strictly necessary to supplement privately known or specific-device-extracted data with other generally known data to identify a risk event or cause of action as having arisen. However, in order to supplement extracted data about entities with other known data about the same entities obtained from broader sources, the broader source data should be processed using consistent entity pseudonymizing techniques to enable accurate entity matching and records linking in the data supplementation process.

An information identity management system should be employed to execute this task and should be regularly synchronized with data extracted from all associated devices and knowledge bases.

Synchronization intervals would be a matter of policy implementation for the practitioner of this method and data synchronization should take place ideally at least as regularly as a report is pro-actively requested by a user of the system, or else more regularly to automatically identify, in real-time or near real-time, the actual or potential emergence of new causes of actions between legal entities without unduly exposing entity-confidential information to unauthorized recipients.

A user or beneficiary of the system described in this document with a de-pseudonymizing key for one or more entities may request or automatically receive reports for such specific entities including, where legally necessary, based on appropriate authorizations and permissions. For example, an authorized agent of Acme Corporation LLC could receive de-pseudonymized reports related to Acme and its legal relationships with other legal entities.

Supplemented or non-supplemented data contained in the federated databases must be queried for correlations with the legal domain knowledge base and matches, or near matches according to a match threshold specified as a matter of policy by the user, reported on. Various algorithms that efficiently search for pattern occurrences may be deployed in this component of the system. In an exemplary embodiment continuous querying of the federated database system for correlations with the conditions required to establish a cause of action would be performed using node and node path similarity algorithms and may include a lower-limit similarity value or score as a threshold condition to generate an output report. In a further exemplary embodiment, reports generated by the method could include a report on the nature and extent of the legal remedies available to an entity in relation to the causes of action reported on.

The method described in the foregoing may therefore include training one or more models configured to recognize, classify and/or identify data elements within a set of data elements relating to one or more of: (i) entity-identities, entity-attributes, entity-relationships, entity-roles, entity-actions, and factual elements relating to one or more of: events, quanta or co-ordinates; (ii) facts that may constitute facta probanda in relation to one or more legal causes of action or (iii) facts that constitute facta probantia in relation to one or more facta probanda. The models may be configured to receive a set of data elements as input and to output one or more data structures including relevant data elements identified and/or an indication as to which, if any, predefined threshold has been met. In other words, the models may output and indication as to which, if any, causes of action are met given the facts represented in the set of data elements.

It should be noted that while legal systems are effectively rules-based or precedential systems, the interpretation and application of those rules as well as the identification of degrees of precedential correlation between past cases and current facts are generally acknowledged to be opinion-based processes. This inherent element of subjectivity within the process of legal analysis and judicial decision-making manifests clearly in this method through the selection and weighting of various classification categories, labels or sub-labels that an implementor may select for the analysis of legal texts or other information by means of the method described herein.

As a result, there can be no single or objectively “correct” set of classification categories, labels, sub-labels and levels that may be applied to training materials used in relation to any particular system to train a machine or system of machines (a process known as “machine-learning”) to process information into data structures and to extract, classify and identify, within a corpus or corpora of information, different entities, the existence of legal relationships between those and other entities, the nature of those relationships, the roles occupied by entities within those relationships, the rights and obligations of those entities in relation to those roles, other facts, including but not limited to facts the presence or absence of which are indicative of the existence of a particular cause of action within a particular legal system (the facta probanda) and other facts whose presence or absence are indicative of the existence or absence of further facts, as mentioned above.

In some embodiments, weightings may be added to judgments sourced from apex courts compared to judgments sourced from lower courts and additional complex weightings based upon metadata integrity and evidential weight assigned to evidential materials. Different embodiments may make use of different training tools, for example including machine learning systems, including deep learning systems, whether on a supervised, unsupervised or semi-supervised basis. Some embodiments may implement machine learning using neural networks. It should be appreciated that a machine learning approach to the development of the legal system knowledge base may include selecting specific machine learning approaches for different elements of the method, for example, based on the type and quantity of data available. Different combinations of machine learning approaches may be implemented within different elements of the overall system.

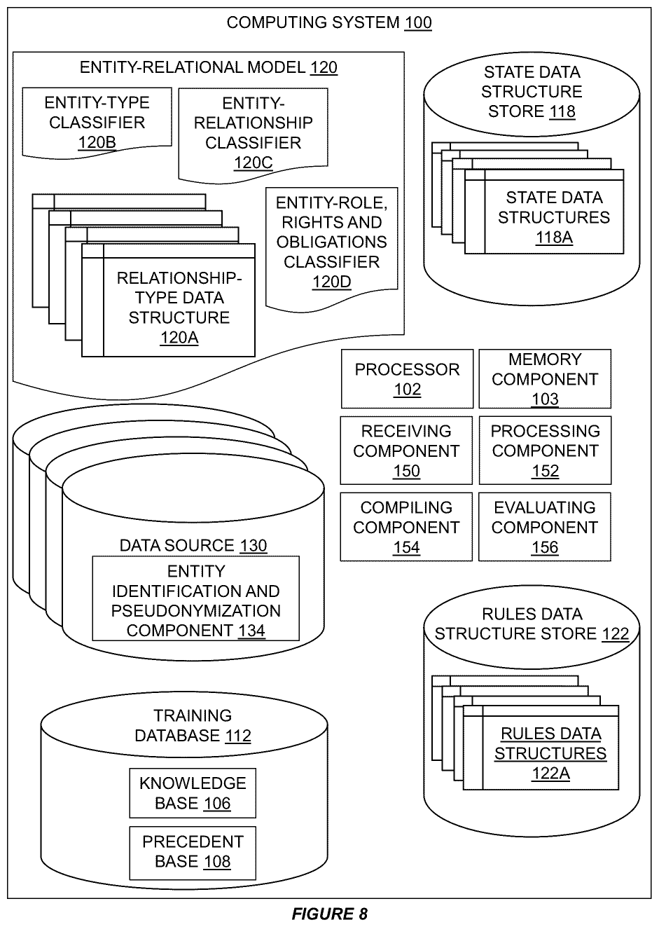

FIG. 8 is a schematic diagram showing an example computing system (100) for machine learning-based identification of a condition defined in a rules-based system according to aspects of the present disclosure.

The computing system (100) may be in the form of networked computing devices including processors capable of processing data, memory units capable of storing data and communications devices capable of sending data to other devices and locations. The computing system (100) may for example include a server computer, which may be in the form of a cluster of server computers, a distributed server computer, cloud-based server computer or the like. The physical location of the server computer may be unknown and irrelevant to users of the system and method described herein.

The computing system (100) may include a processor (102) for executing the functions of components described below, which may be provided by hardware or by software units executing on the computing system (100). The software units may be stored in a memory component (103) and instructions may be provided to the processor (102) to carry out the functionality of the described components. In some cases, for example in a cloud computing implementation, software units arranged to manage and/or process data on behalf of the computing system may be provided remotely or in a distributed fashion.

The computing system (100) may have access to or may maintain a training database (112) in and from which training data may be stored and accessed. The training database (112) may include a knowledge base (106) and a precedent base (108).

The knowledge base (106) may include training data relating to all the required data elements (e.g., being associated with facta probanda and/or facta probantia) for all the different conditions and/or predefined thresholds (e.g., being causes of action within an expected legal system). The knowledge base (106) may further include training data relating to the various ways and circumstances in which such required data elements (facta probanda and/or facta probantia) have been recognized to have been established by using one or more content processing techniques/algorithms, as discussed herein. The knowledge base may for example include data elements which have been classified and/or labelled as required data elements for different types of predefined thresholds.

In order to enable the computing system to identify whether a cause of action has arisen or may arise, the computing system requires training data to train the various models, algorithms, etc. to evaluate data elements against a predefined threshold according to aspects of the present disclosure.

The training data may be provided by a user of the system, such as a skilled practitioner of the relevant field. The user may provide the data via a user device in network communication with the computing system, or the user may be in direct control of the computing system. In some embodiments, the training data may be mined by the computing system from one or more databases selected by the user. The training data may be received by the system and stored in one or more databases accessible to components of the system.

The system may access the training data and use the data to create/build the knowledge base (106), such as a legal knowledge base. The knowledge base may include a record or representation of all the required elements or facta probanda for all the different causes of action within an expected legal system. In some embodiments, this may include, for each required element, as many further records as possible of the various ways and circumstances in which such elements or facta probanda have been recognized to have been established by one or more facta probantia, using the content processing steps or algorithms described herein.

The knowledge base (106) may serve as the base for returning results to queries for correlations between new sets of factual circumstances arising between legal entities and past sets of factual circumstances that gave rise to causes of action between legal entities in the past.

The knowledge base (106) may be used to train components the machine-based system to recognize, classify and identify one or more of: entity-identities, entity-attributes, entity-relationships, entity-roles, entity-actions, events, quanta or co-ordinates; facts that may comprise facta probanda in relation to one or more legal causes of action; and facts that may comprise facta probantia in relation to one or more of the facta probanda.

In some embodiments, further training data may be used to build/create the precedent base (108). To build the precedent base (108), the user must provide the computing system (100) with training data relating to previous legal judgements, evidential material relevant to such past judgements, or the like. Creating the precedent base (108) may include codifying or organizing the legal system's rules so as to determine whether a cause of action has arisen between two or more legal entities based on the necessary facta probanda for any such action to arise. Codifying the legal system's rules may include expressing the facta probanda for particular causes of action to arise between two or more legal entities as logical conditions that must be true for any such cause of action to arise between said legal entities.

The precedent base (108) may therefore include training data relating to previous cases and/or judgements in the relevant legal system. It should be appreciated that there is no single or objectively “correct” set of classification categories, labels, sub-labels and levels that may be applied to training materials used in relation to any particular system to train the machine-based system to process information into data structures, such as the knowledge and precedent bases, and to extract, classify and identify, within a corpus or corpora of information, different entities, the existence of legal relationships between those and other entities, the nature of those relationships, the roles occupied by entities within those relationships, the rights and obligations of those entities in relation to those roles, other facts, including but not limited to facts the presence or absence of which are indicative of the existence of a particular cause of action within a particular legal system and other facts whose presence or absence are indicative of the existence or absence of further facts.

The knowledge base, precedent base and/or various models may be continuously re-evaluated and/or re-calibrated in order to achieve greater consistency and accuracy outputs. This may for example include updating such data structures in response to new case precedents and rulings published in relation to that legal system.

The computing system (100) may be configured to execute one or more algorithms, such as deep learning algorithms, on a set of data including training data stored in the training database (112) for outputting classifiers and/or models, such as an entity-relational model (120). The one or more models may be configured for machine learning-based evaluation of data elements for detection or identification of a condition, such as a cause of action based on facts represented within the data elements. The computing system (100) may be configured to process and record the training data into one or both of the knowledge base (106) and the precedent base (108).

The computing system may include or have access to a state data structure store (118) and a rules data structure store (122) in and from which one or more state data structures (118A) and rules data structures (122A) may be stored, accessed and compared. The state data structure store may be centralized or federated.

The computing system may include or have access to a model repository in and from which one or more models may be stored and accessed. Example models stored in the mode repository include the entity-relational model (120), and the like. The entity-relational model (120) may for example include, incorporate or be made up of one or more of: one or more relationship-type data structures (120A) an entity-type classifier (120B); an entity-relationship classifier (120C); an entity-role, rights and/or obligations classifier (120D), and/or the like.

The computing system (100) may include one or more data sources (130) in and from which data elements may be stored and retrieved for processing. In some embodiments, different data sources may be under the control of different entities and may for example be physically and/or logically separated. In some embodiments, an entity identification and pseudonymization component (134) may be provided at each data source (130) for local processing of data elements stored within the data source (130) without (or before) transmitting the data elements over a communication network. The entity identification and pseudonymization component (134) may include an entity registration and encryption component which receives data elements from a data source, processes the data elements to perform entity identification and pseudonymization and persists the processed data elements into one or both of an identity encrypted device fact base and an identity encrypted knowledge fact base from where the processed data elements may be accessed and input into a model for evaluation against a predefined threshold. This may enable entity identification and pseudonymization to be performed before transmitting the data elements over a communication network for remote processing. In some embodiments, one or more of the one or more data sources may be in the form of a user device in data communication with the computing system (100). The user device may be any suitable computing device having a communication functionality (such as a mobile phone, a tablet computer, personal digital assistant, laptop computer, etc.) and may be accessible to and/or usable by a user of the system.

The computing system may include or have access to one or more third party data repositories from which supplemental data relating to data elements within a set of data elements may be retrieved. The third-party data repositories may be web-addressable repositories, such as third-party websites or the like.

The computing system (100) may be configured to communicate with one or more of the user device, training database (112), third party data repositories, model repository, a composite database and data sources (130) via a suitable communication network, such as the Internet. Communication over the network between the computing system and other endpoints may be secured, for example using SSL, TLS or the like.

The computing system (100) may include a receiving component (150) arranged to receive data elements representing natural language phrases extracted from a natural language record. Receiving the data elements may include receiving them from a data source or retrieving them from a store or database or the like.

The computing system (100) may include a processing component (152) arranged to process the data elements, which may include identifying in the data elements features including one or more of: an entity; a relationship between the entity and another entity; and attributes of the relationship.

The computing system (100) may include a compiling component (154) arranged to compile a state data structure based on the entity, relationship and attributes of the relationship identified in the data elements. The state data structure may represent the relationship between the entity and another entity.

The computing system (100) may include an evaluating component (156) arranged to evaluate the state data structure for occurrence of a condition defined in a rules-based system. This evaluation may include continually or periodically receiving further data elements and evaluating the further data elements against the state data structure for occurrence of the condition described in the rules data structure store (122).

The method disclosed herein enables skilled practitioners to train and utilize a machine-based system to identify or anticipate the potential or actual emergence of a variety of causes of loss or harm and/or the emergence of a variety of actual or potential causes of action between entities within rules-based systems and for assessing the merits of any such actions in a real-time or near real-time environment without human involvement and without causing confidential information relating to an identified natural or juridical entity to be merged into one data location, moved between data locations, or otherwise transferred across a data network.

The particular meaning of the word “action” in the aforementioned context of a “cause of action” should be understood to be distinct from other references to the word “action” elsewhere in this description to describe ordinary actions that may be taken by entities, such as where an entity takes the action of signing a contract or the action of paying an invoice.

Without detracting from or limiting the general meaning ordinarily given to the term, reference to a “corpus” should be deemed to include any body, artefact, store, repository or piece of data or information in the broadest possible terms and the pluralized term “corpora” should be construed accordingly.

Reference to a “risk event” should be interpreted to mean the materialization or arising of a set of circumstances in which a negative consequence, such as a penalty, or other form loss, damage or harm has been suffered by one or more entities or where the suffering of such a consequence is imminent or reasonably foreseeable, particularly but not limited to where no mitigatory actions are taken in response to the materialization or arising of such an event.

Aspects of the present disclosure may provide a data model and classification system to:
describe and/or represent the rules of a rules-based system as sets of conditional-if statements and logical assertions using an ontological framework that includes elements consisting of entities, relations; objects, attributes; actions and events;
describe and/or record the relationships that may arise between entities within the rules-based system, including the roles, rights and/or obligations that may be held by such entities within such relationships;
describe and/or record the particular causes of action that may arise between natural or juridical entities within a rules-based system, as well the remedies associated with such actions;
describe and/or record the specific elements (or facta probanda) that are necessary to sustain a particular cause of action within a rules-based system;
process and classify, and/or utilize systems and methods for processing and classifying, information into data structures and formats capable of being processed and/or queried by computing devices and machines for the purposes of training and/or utilizing a machine and/or neural network, or a system of machines and/or neural networks to extract, classify and identify, from sets or corpora of data, different entities, the existence of different types of relationships between those and other entities, the nature of those relationships, the roles occupied by entities within those relationships, the rights and obligations of those entities held in relation to those roles, as well as other facts, including but not limited to facts the presence or absence of which are indicative of the existence of a particular cause of action within a particular rules-based system and further facts whose presence or absence are indicative of the existence or absence of the aforementioned facts specifically by utilizing information processing and information extraction tools to process training corpora for entity recognition and fact extraction, including entity attribute extraction, entity relationship extraction, object extraction, action extraction and event extraction and represent the extracted information using the same ontological framework used to express the system's rules as sets of conditional-if statements and logical assertions;
assign and/or utilize systems and methods to assign anonymized or pseudonymized identifiers to entities using a synchronizing identity management system; and
identify or anticipate, and/or utilize systems and methods to identify or anticipate, from sets or corpora of data, without causing information regarding an identified natural or juridical entity to be transferred across a data network or otherwise moved between data locations, whether, in relation to one or more natural or juridical entities subject to a rules-based system, a particular risk event or cause of action or a right to a particular remedy has arisen, or may be anticipated to arise on a relative scale of probabilities assessed in accordance with specified or predefined probability thresholds.

Without limiting the potential scope of application of the disclosed method, the method is particularly suitable for a rules-based system where the rules have been formulated in natural language and where there are: recognized types or classes of entities; recognized sets of relationships that may arise between such entities; recognized types of roles and responsibilities that may arise within such relationships; and a defined number of specific actions or causes of action that may arise where each cause of action has a specified (but not necessarily fixed) set of elements or facta probanda that must be established in order for any such cause of action to arise or be enforced in the rules-based system. Typically, within such systems there may also be defined sets of the different types or ranges of potential consequences, penalties or remedies that may be applicable specific types of actions within the rules-based system. From time-to-time new rules may arise within such a rules-based system. Furthermore, although in some rules-based systems very rarely, new types of entities, relationships, roles, rights, responsibilities and causes of action may also arise as a result of new rules or as a result of new interpretations of old rules. Where new rules or new types of entities, relationships, roles, rights, responsibilities or causes of action do arise at any time after an initial implementation of this method, they may also be given expression within the same entity-relational model and ontological framework in order for the method to remain capable of application and utilization towards any such new developments.

Basing the disclosed method on an entity-relational ontological model for a rules-based system is useful in order to produce the outputs and outcomes towards which this method is directed because, if there are recognized sets of types of entities, relationships and roles within the system as well as recognized sets of actions or claims that may arise between entities within the system according to the systems rules, each with its own recognized sets of necessary elements, then it is possible to represent some or all of such entities, relationships and roles in an entity-relational database, to list some or all such sets of actions or claims that may arise between such entities (or at least as many types of actions or claims as an implementor of the method may initially select to focus on), each with their own recognized sets of necessary elements, in a database or series of databases capable of being queried against sets of logical conditions representative of the emergence of different types of risks or causes of action and furthermore to train algorithms to process sets of information in order to recognize matches between the characteristics of such processed information and stored representations of the circumstances under which a particular risk event or cause of action may arise whether on an absolute-match basis or according to a pre-determined matched similarity or probability threshold.

In addition to a potentially very large body of precedent types of facta probantia, ways and circumstances that may be recognized as giving rise to a particular cause of action within a rules-based system, evolving rules-based systems may continue to recognize and add new ways and circumstances to their precedent bases over time and skilled practitioners within a rules-based system would endeavor to follow the development of that rules-based system so as to be able to recognize when any such new ways and circumstances arise.

In an exemplary embodiment of this method, a composite knowledge base consisting of a rules base and a precedent base must be created containing a record or representation of all of the rules regarding the necessary elements or facta probanda for all of the different causes of action within that rules-based system and, for each such element, all or as many further records as possible of the various ways and circumstances in which such elements or facta probanda have historically been recognized to have been established by one or more facta probantia, in an exemplary embodiment using one or more state of the art information extraction and data labelling techniques applied in a manner consistent with the recommended features of the data model described herein such that the extracted data outputs are capable of representation within an entity-relational database modelled on a ontological framework that includes entities, relations, actions and/or events. For example, relationships may be extracted as relation triples. Specifically, an implementor of the disclosed method must train a machine-based system to extract facts from corpora of information. The precedent knowledge base should comprise of information regarding entity-identities, entity-attributes, entity-relationships, entity-roles, entity-actions, events, quanta or co-ordinates; facts that have been previously judged to constitute facta probanda in relation to one or more causes of action and facts that have been previously judged to constitute facta probantia in relation to one or more of the facta probanda. Alternatively, where an implementor elects to utilize this method to train a machine-based system to identify priority or specific risk events or priority or specific causes of action only, the rules base and precedent base may be populated with just the necessary elements or facta probanda for those risk events or causes of action and, for each such element, the precedent base would be populated with all or as many further records as possible of the various ways and circumstances in which such elements or facta probanda have historically been recognized to have been established by one or more facta probantia.

Table 4 below illustrates how multiple different sets of facta probantia may be relevant to the establishment of a specific factum probandum in a hypothetical legal system. Table 3 assumes that the legal system does not require a signed and witnessed contract for an agreement of sale of moveable property to be validly concluded but that witnessing is a requirement for an agreement of sale of immoveable property to be validly concluded.

TABLE 4

| | Necessary | Example of a recognized set of facta probantia that |
|---|---|---|
| | Element/Factum | would give rise to the establishment of the relevant |
| Action type | Probandum | factum probandum. |
| Action for | A Seller | A document (document object X) recording the |
| payment of | concluded an | sale of an item of property by Entity X to Entity Y |
| purchase price | agreement of | for a specific sum was created on a particular date. |
| of moveable | sale with a | Document object X was signed by Entity X on a |
| property | Purchaser. | particular date. |
| | | Document object X was signed by Entity Y on a |
| | | particular date. |
| Action for | A Seller | A document (document object X) recording the |
| payment of | concluded an | sale of an item of property by Entity X to Entity Y |
| purchase price | agreement of | for a specific sum was created on a particular date. |
| of moveable | sale with a | Document object X was signed by Entity X on a |
| property | Purchaser. | particular date. |
| | | Entity X's act of signing document object X was |
| | | witnessed and also signed by Entity Z on the same |
| | | date that Entity X signed document object X. |
| | | Document object X was signed by Entity Y on a |
| | | particular date. |
| | | Entity Y's act of signing document object X was |
| | | witnessed and also signed by Entity Z on the same |
| | | date that Entity Y signed document object Y. |

All facts pertaining to a particular entity may be considered as the “set” of n-facts pertaining to that entity and a system may be programmed to (i) identify when the set of n-facts pertaining to an entity contains one or more subsets of recognized facta probantia that indicate or approximate (to within a specified probability threshold) the establishment of one or more facta probanda; (ii) add deduced facta probanda to the set of n-facts and (iii) identify when the set of n-facts contains one or more subsets of facta probanda that indicate or approximate (to within a specified probability threshold) the establishment of one or more risk events or causes of action.

It is possible for practitioners to use a variety of different processing approaches and tools when building up a machine learning system and training it to recognize the existence of relevant facta probantia and relevant facta probanda. In an exemplary embodiment of this method, an implementor may utilize neural networks trained on a supervised basis with the best performance likely to be associated with the use of large quantities of appropriately labelled training data.

A skilled implementor of this method must therefore apply a machine learning approach to the development of the entity-relational rules-based system knowledge base but may select specific machine learning approaches for different elements of this method with due regard for the nature of the rules and the type and quantity of training data available and different combinations of machine learning approaches may be implemented within different elements of the overall system.

For machine learning implementation within an entity-relational rules-based system, programmatic rules may be used in conjunction with derived mathematical correlation models, particularly where the programmatic rules enhance the appropriateness of the labels used to train the network.

Fact extraction from training or production corpora consisting of natural language texts for the purpose of training a system to be able to recognize matches of the relevant facta probanda and facta probantia between production corpora and the trained knowledge base should take into account potential synonyms or semantically similar words in order to identify correlations between the indexed facts and the relevant sets of conditional statements that indicate that a risk event or cause of action has arisen. In an embodiment of this method, part-of-speech tagging may be applied to expressions of the rules as well as training and production corpora texts and, in an exemplary embodiment, word and/or phrase embeddings in the form of semantic vector space models may be utilized to enable recognition of different semantic representations of equivalent facts, expressions of rules and/or conditions.

For example, the words “motor vehicle” and “car” may be recognized to be synonyms as may the words “defective” and “non-functioning” such that where fact information extraction processes identify that a “motor vehicle” was sold with the attribute of a “defective” brakes, that would be recognized as semantically equivalent to a “car” being sold with “non-functioning” brakes. Similarly, where indexing of past judgments on the rules identifies that “defective” brakes have been held to be a “material defect” of a “motor vehicle” that give rise to an action for payment of a refund of the purchase price, the system would recognize that an action for payment of a refund of the purchase price would also arise by reason of the existence of a “material defect” in the item sold where a “car” is identified to have been sold with “non-functioning” brakes. In an exemplary implementation of this method, word embeddings or semantic vector space models trained on corpora deemed to be most relevant for the rules-based system concerned may be used. In an exemplary implementation for a hypothetical legal system, such corpora may include copies of all past judgments of precedential value to that legal system.

In an exemplary embodiment, word and/or phrase embeddings in the form of semantic vector space models may be utilized to enable recognition of different semantic representations of equivalent facts, expressions of rules and/or circumstances. Such embeddings may be generated by neural network, co-occurrence, probabilistic and other methods using pre-trained algorithms and/or, in an exemplary embodiment, using neural network techniques such as the Word2vec algorithm trained on specialized domain corpora such as, in the case of a legal system, published law reports, textbooks and evidential materials.

In an exemplary embodiment of this method, the knowledge base would itself be trained on past rule adjudications and judgments and various other training materials including, in an exemplary embodiment, various evidential materials pertaining to those adjudications and judgments.

In an embodiment of the method, all past judgments on the rules that have not been overturned on appeal or otherwise become obsolete, and all evidential materials relevant to such past judgments, would be indexed and classified for a particular rules-based system using an entity relational ontological classification method as described herein, and as many relevant classification levels, classification types and sub-types would be utilized by the practitioner of the method as is determined to be appropriate or commercially feasible with regard for the fact that the accuracy or reliability of outputs produced by an automatic classification-based system trained with a fixed set of training data will improve with an improvement in the relevancy of the different classification levels and classification types used in the training process; and/or a fixed set of relevant classification labels may increase with an increase in the number and range of relevant and appropriate training materials.

Although it is theoretically possible to build a knowledge base using only a broad statistical approach to learning based on holistic corpus training where only an ultimate case-assessment output is captured against the holistic corpus for learning purposes, such a method would require an extreme amount of training materials and time before it could begin to produce reasonably accurate results. An ideal embodiment of this method would capture and index not only the final case-assessment outputs that correlate positively to the entire holistic corpus of information that is relevant to the case, but also the intermediate conclusions reached in the case based on specific facts or circumstances extracted from that corpus, particularly where the ultimate conclusion of a case was arrived at by utilizing a process of deductive or inductive reasoning that followed from intermediate conclusions reached, so that the machine-based system may be trained to reach similar conclusions when similar factual or circumstantial elements are encountered in future cases of the same or a reasonably similar type.

The knowledge base will therefore provide a basis for identifying whether the conditions for any particular risk event or cause of action are met or are approximated and for returning results to queries for correlations between new sets of factual circumstances arising between entities with past sets of factual circumstances that previously gave rise to risk events or causes of action arising in relation to particular entities, including, in an exemplary embodiment, by identify semantic matches or semantic approximations existing between different semantic permutations of the rules, facta probanda and facta probantia.

It is important for implementors to recognize that while rules-based systems are often regarded to be objective and precedential in nature, the interpretation and application of rules as well as the identification of degrees of precedential correlation between past cases and current facts may also be recognized to frequently entail the formation of opinions which may differ amongst different adjudicators of the rules notwithstanding the same set of facts or rules applicable to those facts. Similarly, elements of subjectivity are present in this method through the selection and weighting of various classification categories, labels or sub-labels that an implementor may select for the indexing and analysis of legal texts or other information.

As a result, there can be no single or objectively “correct” set of classification categories, labels, sub-labels and levels that may be applied to training materials used in relation to any particular system to train a machine or system of machines (a process known as “machine-learning”) to process information into data structures and to extract, classify and identify, within a corpus or corpora of information, different entities, the existence of legal relationships between those and other entities, the nature of those relationships, the roles occupied by entities within those relationships, the rights and obligations of those entities in relation to those roles, other facts, including but not limited to facts the presence or absence of which are indicative of the existence of a particular cause of action within a particular entity-relational rules-based system (the facta probanda) and other facts whose presence or absence are indicative of the existence or absence of further facts.

However, some classifiers, classification structures and classification values will tend to result in more accurate and more consistent interpretative outcomes than others, particularly so for entity-relational rules-based systems that give recognition to the principle of stare decisis or a substantially similar rule, being the doctrine that obligates courts to follow historical cases when making future rulings on cases presenting with similar facts.

The impact of a principle such as stare decisis is that although judgments may be recognized to be expressions of opinions, a prior judgment that has not been overturned on appeal or invalidated by another higher decision maker may, for all intents and purposes, be presumed to be correct until held to the contrary by a decision maker with the requisite authority to do so, or until a specific change to the rules vitiates the effect of the prior judgment.

An implementor of this method within any particular rules-based system should therefore continue to apply reasonable care, skill and expertise to continuously evaluate and/or recalibrate their selected classifiers and input weightings in order to achieve greater consistency and accuracy in the outputs produced by this method over time, including but not limited to in response to new case precedents and rulings published in relation to that rules-based system.

It is however assumed that not every person who may want to utilize this invention would want to build out and train their own embodiment of this system and method, nor would it necessarily be economically feasible for any such person to do so. It is anticipated that, over time, the most accurate embodiments and applications of the method would most likely be method implementations by those with the greatest access to relevant training materials and classification resources. Leading embodiments could be made available to other persons for use.

In relation to many legal systems specifically, information pertaining to cases that have been heard by a court, including evidence presented in those cases, become matters of public record meaning that large numbers of training materials should be accessible for those legal systems. Private arbitration of cases often results in case records not becoming public records, however this practice of keeping certain case records private and confidential means only that certain sets or sub-sets of training materials may be accessible to some, but not all practitioners of this method.

An implementor of this method may, in the calibration of algorithms to perform calculations of the sort contemplated below, elect to add additional weightings to judgments sourced from apex decision makers compared to judgments sourced from lower decision makers.

Just as an experienced lawyer or judge is able to identify when all of the elements necessary to sustain a particular cause of action are present, so too will a machinated embodiment of this system and method, where properly trained and using methods as described herein, be able to identify whether all of the necessary element sets of entities, relationships and events are present based on the facts known to the system. Partial but near-complete matches of legal action characteristic elements could even be reported on by such a system based on risk management and probability threshold policies applied to the system.

Within the context of a specific legal case with a known issue to be resolved, “relevant” facts are those which tend to prove or disprove an issue in dispute in the case. However, in the absence of a known legal case, all facts have some potential for legal relevancy to a greater or lesser extent. Therefore, the greater access a system can have to all known facts, the more likely it is that the system would be able to identify a greater potential number of causes of action in the future.

Some embodiments of this system therefore not only model and map entity-relational rules-based systems based on past judgments and evidential materials in order to compare subsequent collections of materials gathered from specific, and potentially privileged, “narrow” sources with the data maps resulting from past judgments and materials, but also supplement narrowly gathered data with data gathered from other broader sources to build out a more complete understanding of potentially relevant entities using an entity-centric knowledge base. This entity-centric knowledge base may be modelled and designed along similar principles to the entity-oriented relational ontological design principles outlined herein for an entity-relational rules-based system or data from such sources may be required to be mapped for supplementation purposes using appropriate application programming interfaces.

To promote accuracy over time, the entity-centric knowledge base must be maintained because new entities come into existence (and must be added), attributes and relations of an existing entity change (and should be updated), and the variations of entity names must be recorded. Manual updates would tend to lag significantly behind real time. Thus, the knowledge base should ideally be maintained through automatic indexing and information discovery techniques to routinely suggest or make updates through ongoing information extraction processes.

An exemplary embodiment would incorporate a method for performing corpus-level analysis to resolve/highlight contradictions and estimate confidence for each individual fact using confidence estimates.

Practitioners should bear in mind that for such a system as is disclosed by the present invention to be generally accepted within a legal community, the final output of this system would ideally be a form of judgment or report on whether a cause of action has arisen, or may arise, and the layers of fact analysis within that judgment or report should ideally lead to a legal conclusion that is humanly recognizable and based on humanly generally accepted principles of law. So while a practitioner can take as a recommended early step in the implementation of any particular or preferred embodiment of this invention, the selection of one or more sets of existing content processing, IE or NLP systems and existing foundation tag sets available in the marketplace today in the process of processing corpora of information, the ultimate classification outputs of the processing tools should be carefully mapped from basic or general linguistic, semantic and numeric concepts to legal domain relevant labels and outputs using the entity-relational rules-based system ontological modelling method as described herein to identify legal and non-legal entities; entity attributes, entity relationships, entity roles, rights, obligations, facts and events that are meaningful within the relevant entity-relational rules-based system model. In an exemplary embodiment of the method disclosed herein, the task of writing up first or final draft natural language reports could include generating a natural language summary of the relevant facts that caused a correlation to arise with a particular cause of action and by converting the relevant facts represented in the knowledge graph to natural language format, using such natural language reports as inputs to a LLM that had been sufficiently trained on domain relevant texts such as, in the case of a legal system, historical law reports and generating a further natural language report on the existence, nature and extent of the legal remedies available to an entity in relation to the causes of action arising in terms of the rules reported on.

Not only does the method disclosed herein offer the potential for decisions to be understood by entity-relational rules-based system participants (which would be important to generate trust and acceptance), this method also importantly allows for the possibility of potential errors to be discovered and for anomalous decisions to be explained in a way that facilitates the development of legislative amendments to produce socially desired outcomes. Arriving at conclusions that are mathematically grounded but that are nonetheless mapped to entity-relational rules-based system reasons, enables those reasons to potentially also become future rules and thereby promote continuous and progressive entity-relational rules-based system development, including in a manner that may be programmed to be consistent with the system's founding rules.

Aspects of the present disclosure may provide a method for training and utilizing a machine-based system to determine whether a cause of action has arisen or may arise in relation to one or more entities subject to an entity-relational rules-based system without causing confidential information relating to an identified natural or juridical entity to be merged into one data location, moved between data locations, or otherwise transferred across a data network which method consists of: classifying types of legal entities that may exist within an entity-relational rules-based system using selected entity classifiers; classifying types of relationships that may arise between said entities using selected relationship classifiers; classifying types of roles that may be occupied by said entities in said relationships using selected role classifiers; codifying the entity-relational rules-based system's rules for determining whether a cause of action has arisen between two or more legal entities based on the necessary facta probanda for any such action to arise; classifying and labelling information sourced from one or more corpora of information using the said selected entities, relationships and roles classifiers; training a machine system to recognize entity-identities, entity-relationships and entity roles within relationships from one or more corpora of information; training a machine system to extract facts from one or more corpora of information; using the trained machine system to recognize and extract entity-identities, entity-relationships, entity-roles, rights and/or obligations and other facts from one or more corpora of information; assigning pseudonymized identifiers to entity identities identified by the trained machine system within one or more corpora of information; recording pseudonymized entity related information at one or more data locations in a federated database system; computing the correlation between aggregated pseudonymized entity related information in the federated database system and the codified rules for determining whether a cause of action has arisen between said entities.

The machine-based system and federated database system may include of a networked system of computational devices including processors capable of processing data, memory units capable of storing data and communications devices capable of sending data to other devices and locations. Classifying entities may include (i) distinguishing entities with legal persona from entities without legal persona; (ii) distinguishing fungible entities from non-fungible entities. Classifying roles may include classifying the types of rights or obligations that may be held by entities occupying such roles in relation to other entities. Codifying may include expressing the sets of facta probanda for particular causes of action to arise between two or more legal entities as logical conditions that must be true for any such cause of action to arise between said legal entities. Training of a machine system to recognize, classify and identify facts includes facts that may comprise of: (i) entity-identities, entity-attributes, entity-relationships, entity-roles, entity-rights, entity-obligations, entity-actions, events, quanta or and/or co-ordinates; (ii) facts that may constitute facta probanda in relation to one or more legal causes of action or (iii) facts that may constitute facta probantia in relation to one or more facta probanda. Assigning pseudonymized identifiers to inconsistently referenced entities is performed using an entity referencing standardization system. The method may include re-identifying entities from pseudonymized entities to determine the entities to whom particular computed correlations apply.

The method may include reporting correlations using a correlation reporting system.

The reporting system may include generating a report of the entity-identities, entity-attributes, entity-relationships, entity-roles, entity-rights, entity-obligations, entity-actions, events, quanta and/or co-ordinates that have been determined to constitute facta probanda in relation to the reported correlation and/or to constitute facta probantia in relation to those facta probanda.

The reporting system may further include using LLMs and/or legal-domain specific language models to generate a natural language, legal-domain and jurisdictionally specific formatted report of the entity-identities, entity-attributes, entity-relationships, entity-roles, entity-rights, entity-obligations, entity-actions, events, quanta and/or co-ordinates that have been determined to constitute facta probanda in relation to the reported correlation or to constitute facta probantia in relation to those facta probanda.

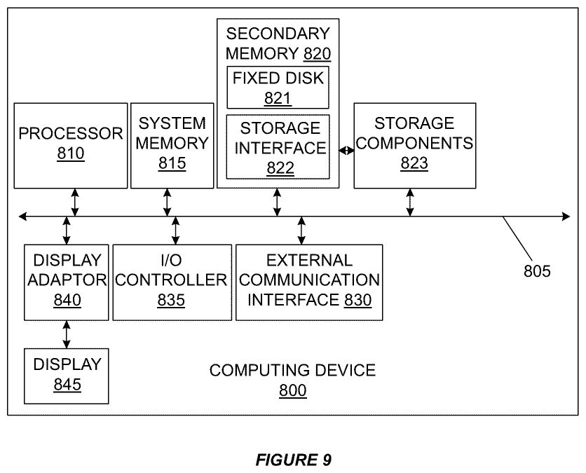

FIG. 9 illustrates an example of a computing device (800) in which various aspects of the disclosure may be implemented. The computing device (800) may be embodied as any form of data processing device including a personal computing device (e.g., a laptop or desktop computer), a server computer (which may be self-contained, physically distributed over a number of locations), a client computer, or a communication device, such as a mobile phone (e.g., cellular telephone), satellite phone, tablet computer, personal digital assistant or the like. Different embodiments of the computing device may dictate the inclusion or exclusion of various components or subsystems described below.

The computing device (800) may be suitable for storing and executing computer program code. The various participants and elements in the previously described system diagrams may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g., in a distributed, cluster or cloud-based computing configuration) and appropriate software units may be arranged to manage and/or process data on behalf of remote devices.

The memory components may include system memory (815), which may include read only memory (ROM) and random-access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signal. The external communications interface (830) may enable communication of data between the computing device (800) and other computing devices including servers and external storage facilities. Web services may be accessible by and/or from the computing device (800) via the communications interface (830).

The external communications interface (830) may be configured for connection to wireless communication channels (e.g., a cellular telephone network, wireless local area network (e.g., using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient or non-transitory computer-readable medium or may be provided via a signal or other transient or transitory means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more displays (845) (which may be touch-sensitive displays) may be coupled to or integrally formed with the computing device (800) via a display or video adapter (840).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for machine learning-based identification of a condition defined in a rules-based system comprising:
receiving, from a data source, data elements extracted from a record;
processing the data elements, including identifying in the data elements features including one or more of: an entity; a relationship between the entity and another entity; and, attributes of the relationship;
compiling a state data structure in the form of a graph data structure based on the entity, relationship and attributes of the relationship identified in the data elements, wherein the state data structure represents the relationship between the entity and another entity;
evaluating the state data structure for occurrence of a condition defined in a rules-based system by a model which represents a collection of conditions defined in the rules-based system, wherein the model is trained using machine learning applied to training data comprising corpora of information which include labelled data elements relating to: entities, relationships, attributes of relationships and one or more conditions of the collection of conditions, and wherein evaluating the state data structure by the model includes continually or periodically receiving further data elements and evaluating the further data elements against the state data structure for occurrence of the condition; and,
outputting an alert when the occurrence of a condition is identified or approximated, wherein the alert includes an indication of the condition.

2. The method as claimed in claim 1, wherein the state data structure is in the form of a graph data structure including a fact graph database and a rules graph database, and wherein evaluating the state data structure includes using node and node path similarity algorithms to determine the distance between embedded node-paths relating to an entity in the fact graph database and embedded node-paths in the rules graph database for entities of that particular entity type.

3. The method as claimed in claim 1, wherein identifying features in the data elements includes recognizing, classifying and/or labelling the data elements using one or more entity recognition algorithms.

4. The method as claimed in claim 3, wherein the one or more entity recognition algorithms include one or both of: conditional random fields; and, hybrid bi-directional long short-term memory/convolutional neural networks (LSTM-CNN).

5. The method as claimed in claim 1, wherein identifying features in the data elements includes using one or more classifiers.

6. The method as claimed in claim 5, wherein identifying features in the data elements includes using one or more of: an entity-type classifier; an entity-relationship classifier; and, an entity-role, rights and/or obligations classifier.

7. The method as claimed in claim 6, wherein the attributes of the relationship include one or more of: an entity role in the relationship; an entity obligation in the relationship; and/or an entity right in the relationship.

8. The method as claimed in claim 1, wherein the model is an entity-relational model for a rules-based system in which ontological elements include one or more of “entities”, “relationships”, “actions” and “events”.

9. The method as claimed in claim 1, wherein the condition is a threshold against which data elements within the state data structure are evaluated to determine when the threshold is met.

10. The method as claimed in claim 1, wherein the rules-based system is an entity relational rules-based system, wherein the entity relational rules-based system is a legal system, and wherein the condition is a cause of action arising in the relationship between the entity and another entity.

11. The method as claimed in claim 1, wherein the data elements include or represent natural language phrases extracted from a natural language record.

12. The method as claimed in claim 1, wherein processing the data elements includes assigning pseudonymized identifiers to entity identities identified in the data elements by performing a cryptographic operation on each of the entity identifies to generate a corresponding pseudonymized identifier.

13. The method as claimed in claim 12, wherein assigning pseudonymized identifiers to entity identities identified in the data elements includes creating a pseudonymized value register of all extracted entities by performing the cryptographic operation on an entity item at the information point at which the entity item has been recognized or extracted.

14. The method as claimed in claim 12, wherein assigning pseudonymized identifiers includes transmitting the pseudonymized identifiers to an entity register for co-referencing standardization.

15. The method as claimed in claim 14, wherein transmitting pseudonymized entity identifiers includes transmitting a standardized name to the information point from which the entity item was extracted.

16. The method as claimed in claim 15, including recording pseudonymized entity related information at one or more data locations in a federated database system.

17. The method as claimed in claim 1, wherein the alert is transmitted to and output via a user device.

18. The method as claimed in claim 17, wherein the alert includes a confidence or proximity score associated with the identification.

19. A system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising:
receiving, from a data source, data elements extracted from a record;
processing the data elements, including identifying in the data elements features including one or more of: an entity; a relationship between the entity and another entity; and, attributes of the relationship;
compiling a state data structure in the form of a graph data structure based on the entity, relationship and attributes of the relationship identified in the data elements, wherein the state data structure represents the relationship between the entity and another entity;
evaluating the state data structure for occurrence of a condition defined in a rules-based system by a model which represents a collection of conditions defined in the rules-based system, wherein the model is trained using machine learning applied to training data comprising corpora of information which include labelled data elements relating to: entities, relationships, attributes of relationships and one or more conditions of the collection of conditions, and wherein evaluating the state data structure by the model includes continually or periodically receiving further data elements and evaluating the further data elements against the state data structure for occurrence of the condition; and,
outputting an alert when the occurrence of a condition is identified or approximated, wherein the alert includes an indication of the condition.

20. A computer program product for machine learning-based identification of a condition defined in a rules-based system, the computer program product comprising a non-transitory computer-readable medium having stored computer-readable program code for performing the steps of:
receiving, from a data source, data elements extracted from a record;
processing the data elements, including identifying in the data elements features including one or more of: an entity; a relationship between the entity and another entity; and, attributes of the relationship;
compiling a state data structure in the form of a graph data structure based on the entity, relationship and attributes of the relationship identified in the data elements, wherein the state data structure represents the relationship between the entity and another entity;
evaluating the state data structure for occurrence of a condition defined in a rules-based system by a model which represents a collection of conditions defined in the rules-based system, wherein the model is trained using machine learning applied to training data comprising corpora of information which include labelled data elements relating to: entities, relationships, attributes of relationships and one or more conditions of the collection of conditions, and wherein evaluating the state data structure by the model includes continually or periodically receiving further data elements and evaluating the further data elements against the state data structure for occurrence of the condition; and,
outputting an alert when the occurrence of a condition is identified or approximated, wherein the alert includes an indication of the condition.
